(19) United States
(12) Patent Application Publication
(10) Pub. No.: US 2016/0080810 A1
(43) Pub. Date: Mar. 17, 2016

(54) SYSTEM AND METHOD FOR CONTENT RECOMMENDATION IN HOME NETWORK

(71) Applicant: Samsung Electronics Co., Ltd., Suwon-si (KR)

(72) Inventors: Bhaskar DUTTA, Noida (IN); Atul KUMAR, Noida (IN)

(21) Appl. No.: 14/854,804

(22) Filed: Sep. 15, 2015

(30) Foreign Application Priority Data
Sep. 16, 2014 (IN) 2667/DEL/2014

(51) Int. Cl. H04N 21/45; H04N 21/443; H04N 21/431; H04N 21/488; H04N 21/254; H04N 21/2187

(52) U.S. Cl. CPC H04N 21/4532; H04N 21/2541; H04N 21/2187; H04N 21/4312; H04N 21/4888; H04N 21/4436; H04N 21/4882

(57) ABSTRACT

A system and a method for content recommendations among devices which are connected or networked with each other are provided. The method includes recommending broadcast channels, programs, recorded contents, normal copied contents or computer generated contents in a networked environment. Recommendation can be send from originator to recipient in the form of text message, audio message or picture representation of the contents.

### CROSS-REFERENCE TO RELATED APPLICATION(S)

This application claims the benefit under 35 U.S.C. §119(a) of an Indian patent application filed on Sep. 16, 2014 in the India Intellectual Property Office and assigned Serial No. 2667/DEL/2014, the entire disclosure of which is hereby incorporated by reference.

### TECHNICAL FIELD

The present disclosure relates to content recommendations among devices which are connected or networked with each other. More particularly, the present disclosure relates to recommending broadcast channels, programs, recorded contents, normal copied contents or computer generated contents in a networked environment.

### BACKGROUND

With advances in communication technologies, there has been a rapid growth in the area of recommendation systems on digital devices like a television (TV), a smart phone, etc.

Systems currently exist that automatically collect television viewing data, for example, particulars of programs being viewed through a particular client device, such as a cable television set-top box and for generating broadcast channel recommendations based on the television viewing data thus gathered. Additionally, video-on-demand (VOD) systems currently exist that record data that identifies VOD purchases associated with a particular viewer. Similar to the broadcast channel recommendations, VOD recommendations may be generated based on the gathered VOD data.

In addition to the above, US 2008/0301737 discloses a mobile telephone device equipped with a content and/or channel recommendation function that is configured to provide a user with content recommendations for watching a television program based upon the user's mobile activities including web browsing, web searching, multimedia content rendered and/or downloaded on the mobile telephone device and calendar information stored on the mobile telephone device. Additionally, the document discloses automatically tracking viewing data pertaining to other users whose contact information is stored in the mobile telephone device and providing a recommendation on the basis of the same. One of the biggest disadvantages of the aforesaid type of automatic recommendation system is that in order to function properly, it needs to be aware of the viewing characteristics or preferences of the user. Additionally, the aforesaid document does not take into consideration that broadcast video contents are not always available all the time and do not contain any suggestion to tackle the aforesaid lacunae. Further, the document only talks about sending channel recommendation and nothing more. Furthermore, the aforesaid document include severe restrictions such as, the recommendation can be done to the user at a selected or specific time like when launching a mobile television viewing program, switching channels, at the end of broadcast, at the time a broadcast is starting, etc. Additionally, as per the aforesaid document, it is only possible to make recommendations in one way, i.e. from mobile device to television.

Apart from the above described automatic recommendation systems, there also exists literature describing systems which form at least one group comprising a plurality of users and share within the group television viewing data of one or more users. By way of example, U.S. Pat. No. 7,594,245 discloses a system comprising a first audio visual device capable of receiving audio visual content, a second and third audio visual device capable of providing data descriptive of the audio visual content, the first audio visual device obtaining recommendations for audio visual content by the second and third audio visual devices, which each categorize the recommendations under a hierarchical relevance scheme, the first, second, and third audio visual devices joined in a first group, a fourth and fifth audio visual device capable of providing data descriptive of the audio visual content, the first audio visual device obtaining recommendations for audio visual content by the fourth and fifth audio visual devices, which each categorize the recommendations under the hierarchical relevance scheme, the first, fourth and fifth audio visual devices joined in a second group, and wherein the first audio visual device filters recommendations using the relevance scheme, and wherein recommendations provided by the first group are filtered by the first audio visual device in a different manner than are recommendations provided by the second group.

This document also does not take into consideration that broadcast video contents are not always available all the time and do not contain any suggestion to tackle the aforesaid lacunae. Further, the document only talks about sending channel recommendation and nothing more. As per this document, recommendation can be done to the user to a selected or specific time only after one user in the network has already seen one video content and personal video recorder has stored the content data and based on that content can give user a choice/suggestion. So the user cannot trigger the recommendation at any time to send it to another user, which means there is no direct human interaction with recommendation system. Furthermore, as per the aforesaid document, recommendation to a particular user will be send based upon all other network user viewing habits along with own viewing habit, which some time could not be so specific.

US 2007/0204308 discloses a channel recommendation bid interface, which allows the representatives to enter placement bids, receiving a bid request on the interface, and displaying a recommendation link to the channel on at least one user recommendation display device based on the bid request. Real time viewership information may also be used in the operation of the channel recommendation system. This channel recommendation bid request, associated with the channel, includes the channel associated with the bid, a bid amount, and a transaction specification. Like a representative for Entertainment and Sports Programming Network (ESPN) may enter a bid associated with ESPN channel, with a bid amount of fifty cents, to be paid based on a viewer of the programming guide selecting to change the channel to ESPN. A programming guide will be provided to user television, where multiple channels will be listed. So while browsing the channels in programming guide, a user may note that a particularly large number of people are watching a particular Show. On this basis, they may elect to view that channel or show. This document also provides a method of operating a shared information system, including, receiving a recorded clip recommendation request, determining a recipient, different from the recommendation source, based on the recommendation request, determining a recorded video clip and an advertisement based on the recommendation request, associating the determined clip and the determined advertisement, associated with the recipient.

This document also does not take into consideration that broadcast video contents are not always available all the time and do not contain any suggestion to tackle the aforesaid lacunae. Further, the document only talks about sending channel recommendation and nothing more. As per this document, recommendation can be done based on recommendation bid by advertiser on channel recommendation page and viewership of a plurality of channels in real time. Furthermore, as per this document channel recommendation will be made by a channel recommendation system and a shared information system. Channel recommendation system is required for initiating the channel recommendation and to handle, it requires share information system, to determine the content and send the recommendation to destination users.

WO 2007105873 discloses a system which is suitable for an originator receiving a digital broadcast to generate channel recommendation data in viewing a specific channel and transmit the generated data to a specific recipient. This document emphasizes more on transmitting the channel recommendation from one terminal to another.

This document also does not take into consideration that broadcast video contents are not always available all the time and do not contain any suggestion to tackle the aforesaid lacunae. Further, the document only talks about sending channel recommendation and nothing more. As per this document, recommendation can be done to a selected or specific time like when originator send one channel recommendation to a specific recipient, first it goes to server, then the server will decide whether recipient is same platform user or not, and, on that basis, it will send the recommendation to recipient terminal or relay system server. Because of the above, the user does not have direct human interaction with recommendation system. Furthermore, this document only talks about transmitting channel recommendation data from originator to destination user television, but it miss the generation of the channel recommendation data.

US 2012/0311633 discloses a system and method of identifying and providing content to a user. The method is performed by a controller with an interne interface. A controller receives electronic program guide data, the electronic program guide data being selectively displayed on a primary display device. An attribute processor parses the received electronic program guide data to identify at least one program description attribute for a currently tuned program. A content processor searches the received electronic program guide and detects at least one further program having the identified at least one program description attribute. The content processor identifies the at least one further program as recommended content in step and a user interface generator generates, a user interface display including the recommended content user interface including a user selectable data item representing the recommended content for display on a secondary display device different from the primary display device.

This document also does not take into consideration that broadcast video contents are not always available all the time and do not contain any suggestion to tackle the aforesaid lacunae. Further, the document only talks about sending channel recommendation and nothing more. Furthermore, as per the document, recommendation can be done to the user to a selected or specific time based on the user profile stored on set top box (STB) and user viewing habit along with program or content be identified after processing of electronic program guide (EPG) data. Because of the above, the user does not have direct human interaction with recommendation system. Additionally, as per the aforesaid document, channel recommendation will be made by the server STB, based on the user profile stored on the STB and content or program found after the processing and searching of EPG data. As recommendation to a particular user will be send based upon the network user viewing habits, in order to function properly, the same need to be aware of the viewing characteristics or preferences of the user.

JP 2007274704 provides a program viewing notifying apparatus which allows viewers to notify third person's recommendation programs and actively transmits information. This document also does not take into consideration that broadcast video contents are not always available all the time and do not contain any suggestion to tackle the aforesaid lacunae. Further, the document only talks about sending channel recommendation and nothing more.

Thus, it can be that there is not much work done for recommending broadcast channels, programs, recorded contents, normal copied contents or computer generated contents in a networked environment. Also, the prior art does not take into consideration facts such as non-availability of broadcast content after certain amount of time period and the device to which the recommendation is intended to be sent is not in an active mode. Thus, there is no generic system/method available to provide recommendations.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a system and a method that allows for content recommendations to be sent among devices which are connected or networked with each other.

Another aspect of the present disclosure is to provide a method for recommending broadcast channels, programs, recorded contents, normal copied contents or computer generated contents in a networked environment, such as a home network. Here, copied contents or computer generated contents could be in the form of data, image, audio, video, or combinations thereof

Another aspect of the present disclosure is to provide a method of sending a television channel recommendation from a recommending device, such as first user's audio visual device like a television, to a destination device, such as another user's audio visual device, in a networked environment. In this way, a user, while viewing a specific channel in his/her audio visual device, can send the same viewing or different channel recommendation to another connected audio visual device in the networked environment.

Another aspect of the present disclosure is to provide a method of sending a computer generated content recommendation from a recommending device to a destination device in a networked environment. In this way, a user that is viewing a specific content in his/her audio visual device, the specific content received from an external hard drive/pen drive connected to his/her audio visual device or a shared external hard drive/pen drive or an internal hard drive connected to a server, can send the same viewing or a different content recommendation to another audio visual device connected in the networked environment.

Another aspect of the present disclosure is to provide a method of sending a personal recorder generated recorded content recommendation from a recommending device to a destination device in a networked environment. In this way, a user that is viewing a specific recorded content in his/her audio visual device, the specific recorded content received from an external hard drive/pen drive connected to his/her audio visual device or a shared external hard drive/pen drive or an internal hard drive connected to a server, can send the same viewing or a different recorded content recommendation to another audio visual device connected in the networked environment.

Another aspect of the present disclosure is to provide a method of sending a protected or shared computer generated or recorded content recommendation from a recommending device to a destination device in a networked environment. In this way, if a user sends a recommendation for a protected content to another user in the networked environment, that protected content will automatically become shared for that other user. After receiving the recommendation from the user, the other user can start streaming that content and view/watch it on his/her audio visual device.

According to an aspect of the present disclosure, if a recommending device or a server finds that any destination device is in a switch OFF mode, the recommending device or the server internally stores content recommendation information, such as content metadata, information of the recommending device, information of destination device, etc. into its database.

According to an aspect of the present disclosure, once any of the previous destination devices is in a switch ON mode and connects with the networked environment, for which content recommendation has been pending and stored in the database, the recommending device or the server immediately sends all the pending content recommendations to that destination device, after fetching them from the database. After sending the pending content recommendations to the destination device, the recommending device or the server automatically deletes that data from the database.

According to an aspect of the present disclosure, if a recommending device sends a channel content recommendation request to any destination device which is currently in a switch OFF mode, then the recommending device or a server can start recording the recommended channel program (show) using a recorder integrated with the recommending device or the server. The recommending device or the server will apply digital rights management (DRM) before storing broadcast content into an internal hard drive or any external storage device, which may be connected physically or through a network. Once finished recording, the recommending device or the server can send the recommendation for the recorded content to the destination device when it is switched ON.

According to an aspect of the present disclosure, a recommending device, that wants to send a recommendation to a destination device in a networked environment, can send the recommendation either forcefully or without force. If the recommending device sends the recommendation forcefully to the destination device, then the destination device will not have any option but to accept the recommendation. Accordingly, the destination device will start playing the recommended content after receiving the recommendation and streaming of recommended content. However, if the recommending device sends the recommendation without force to the destination device, then the destination device will have an option to either accept or deny the recommendation.

According to an aspect of the present disclosure, after receiving the content recommendation from a recommending device, the destination device can have preview of the recommended content at picture in picture (PIP) mode along with the content currently playing.

According to an aspect of the present disclosure, the recommending device, while sending a content recommendation to the destination device, can send few manual text messages, which may be received, say, from a television (TV) remote. Those text messages will be shown at the destination device along with the content recommendation when the destination device receives it from the recommending device.

According to an aspect of the present disclosure, while sending a broadcast channel content recommendation, a recommending device, instead of sending channel information, can add a small picture image of the channel icon along with a recommendation message.

According to an aspect of the present disclosure, while sending a copied content recommendation, a recommending device, instead of sending content metadata, can add a small picture image of the content icon or a thumbnail along with a recommendation message.

According to an aspect of the present disclosure, while sending a broadcast channel content recommendation, a recommending device, instead of sending program metadata, can add small picture image of the program icon or a thumbnail of the program along with a recommendation message.

According to an aspect of the present disclosure, a recommendation can be sent from a recommending device to a destination device in the form of a text message, an audio message, or a picture representation of the contents.

According to an aspect of the present disclosure, if a recommending device sends a channel content recommendation request to any destination device which is currently in a switch OFF mode, then the recommending device will store that channel content recommendation information for that target switched OFF destination device and, once the destination device is switched ON and connects with a network, then, if the recommending device finds that the recommended channel program finished for which recommendation was done, recommending device can provide a repeat telecast recommendation for the same channel program to the destination device.

In accordance with an aspect of the present disclosure, a method of receiving content by a destination device from a recommending device is provided. The method includes receiving information of a content selection, presenting the information of the content selection to a user, and initiating output of the content corresponding to the information of content selection to the user based on at least one predetermined criteria. In an embodiment, the presenting of the information of the content selection to a user may be through a PIP. Also, the destination device may choose to accept or reject playing of the content. The destination device may also choose to postpone the playing of the content and to record the content for viewing later in case the content is a live content.

In accordance with another aspect of the present disclosure, a method of assisting transmission of content by an intermediate device, where the content is being sent from a recommending device to one or more destination devices is provided. The method includes receiving, by the intermediate device operably connected to the recommending device, information of a destination device and information of a content selection, identifying a status of the destination device, and performing at least one of notifying the destination device of the information of content selection, if the destination device is in an ON status, and storing the information of content selection temporarily if the destination device is in a hibernating status or an OFF status.

Other aspects, advantages, and salient features of the disclosure will become apparent to those skilled in the art from the following detailed description, which taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network of interconnected devices in which the method of the present disclosure can be practiced according to an embodiment of the present disclosure;

FIG. 2 illustrates a method of sending a content recommendation to one or more destination devices for output thereupon according to an embodiment of the present disclosure;

FIG. 3 illustrates a method of sending a content recommendation to one or more destination devices for output thereupon including operations according to an embodiment of the present disclosure;

FIG. 4 illustrates yet another method of sending content from a recommending device or a source device to one or more destination devices for outputting thereupon according to an embodiment of the present disclosure;

FIG. 5 illustrates yet another method of sending content from a recommending device or a source device to one or more destination devices for outputting thereupon, including operations according to an embodiment of the present disclosure;

FIG. 6 illustrates a method for sending content from a recommending device to one or more destination devices including optional operations, wherein the recommending device and the destination device are part of a home network environment according to an embodiment of the present disclosure;

FIG. 7 illustrates a recommending device for sending a content recommendation to one or more destination devices according to an embodiment of the present disclosure;

FIG. 8 illustrates a method of assisting transmission of content from a recommending device to one or more destination devices for outputting, the method being adapted to be performed by an intermediate device according to an embodiment of the present disclosure;

FIG. 9 illustrates a method of assisting transmission of content from a recommending device to one or more destination devices for outputting, the method being adapted to be performed by an intermediate device according to an embodiment of the present disclosure;

FIG. 10 illustrates a construction of an intermediate device according to an embodiment of the present disclosure;

FIG. 11 illustrates a method adapted to be performed by a destination device for assisting transmission of content from a recommending device to one or more destination devices for outputting according to an embodiment of the present disclosure;

FIG. 12 illustrates a construction of a destination device according to an embodiment of the present disclosure;

FIG. 13 illustrates a scenario wherein a recommending device is able to receive a recommendation message even in the form of a single press of a button from a remote control device and similarly a destination device is able to receive the content on a single press of a button from a remote control device according to an embodiment of the present disclosure;

FIG. 14 illustrates a recommendation message delivery in a network constituted by a recommending device connected to a single set top box (STB) and a plurality of destination devices according to an embodiment of the present disclosure;

FIG. 15 illustrates a recommendation message delivery in a network constituted by a recommending device comprising an integrated STB and a plurality of destination devices according to an embodiment of the present disclosure;

FIG. 16 illustrates an alternative mechanism for recommendation message delivery in a network constituted by a recommending device connected to a single STB and a plurality of destination devices according to an embodiment of the present disclosure;

FIG. 17 illustrates a recommendation message delivery specifically pertaining to stored content in a network constituted by a recommending device connected to one or more storage devices and a plurality of destination devices according to an embodiment of the present disclosure;

FIG. 18 illustrates an internal configuration of a dataset adapted to store content recommendation messages according to an embodiment of the present disclosure;

FIG. 19 illustrates a server-client configuration for delivery of content recommendation messages according to an embodiment of the present disclosure;

FIG. 20 illustrates a flowchart depicting interactions between a client and a server while sending a recommendation according to an embodiment of the present disclosure, when a recommending device is different from a server;

FIG. 21 illustrates a flowchart depicting a process as performed by a recommending device (which also functions as a server) according to an embodiment of the present disclosure;

FIG. 22 illustrates a flowchart depicting interactions between a client and a server while sending a recommendation according to an embodiment of the present disclosure, wherein the recommending device sends the recommendation message without analysing the status of the connected devices according to an embodiment of the present disclosure;

FIG. 23 illustrates receiving a recommendation command via a voice command while a user is viewing a broadcast channel according to an embodiment of the present disclosure;

FIG. 24 illustrates receiving a recommendation command via a gesture based command while a user is viewing a broadcast channel according to an embodiment of the present disclosure;

FIG. 25 illustrates receiving a recommendation command via a graphical user interface such as a remote control while a user is viewing a broadcast channel according to an embodiment of the present disclosure;

FIG. 26 illustrates an example for depicting a status of a connected device at the recommending device according to an embodiment of the present disclosure;

FIG. 27 illustrates receiving a voice based command selecting a destination device according to an embodiment of the present disclosure;

FIG. 28 illustrates receiving a gesture based command selecting a destination device according to an embodiment of the present disclosure;

FIG. 29 illustrates receiving a graphical user interface command selecting a destination device according to an embodiment of the present disclosure;

FIG. 30 illustrates a recommending device enabling a user to input a customized message according to an embodiment of the present disclosure;

FIG. 31 illustrates receiving an audio message to be included in a content recommendation message according to an embodiment of the present disclosure;

FIG. 32 illustrates receiving a text message to be included in a content recommendation message according to an embodiment of the present disclosure;

FIG. 33 illustrates receiving a voice based acceptance command at a destination device according to an embodiment of the present disclosure;

FIG. 34 illustrates receiving a gesture based acceptance command at a destination device according to an embodiment of the present disclosure;

FIG. 35 illustrates receiving an acceptance command via a graphical user interface such as a remote control at a destination device according to an embodiment of the present disclosure; and

FIG. 36 illustrates an interface made available by a recommending device to a user for enabling selection of stored content according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims or their equivalents.

It is to be understood that the singular forms “a,” “an,” and “the” include plural referents unless the context clearly dictates otherwise. Thus, for example, reference to “a component surface” includes reference to one or more of such surfaces.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Unless otherwise specified, one or more particular feature and/or element described in connection with one or more embodiment may be found in one embodiment, or may be found in more than one embodiment, or may be found in all embodiments, or may be found in no embodiments.

Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any and all details set forth herein are used in the context of some embodiments and therefore should NOT be necessarily taken as limiting factors to the attached claims. Any descriptions of elements and/or features and/or the materials used to create those elements or features, or examples or methods included in the descriptions of the various embodiments are non-limiting and are given as an illustration only. Accordingly, the embodiments can be manufactured, distributed, used, practiced, and carried out in numerous ways.

The attached claims and their legal equivalents can be realized in the context of embodiments other than the ones used as illustrative examples in the description herein.

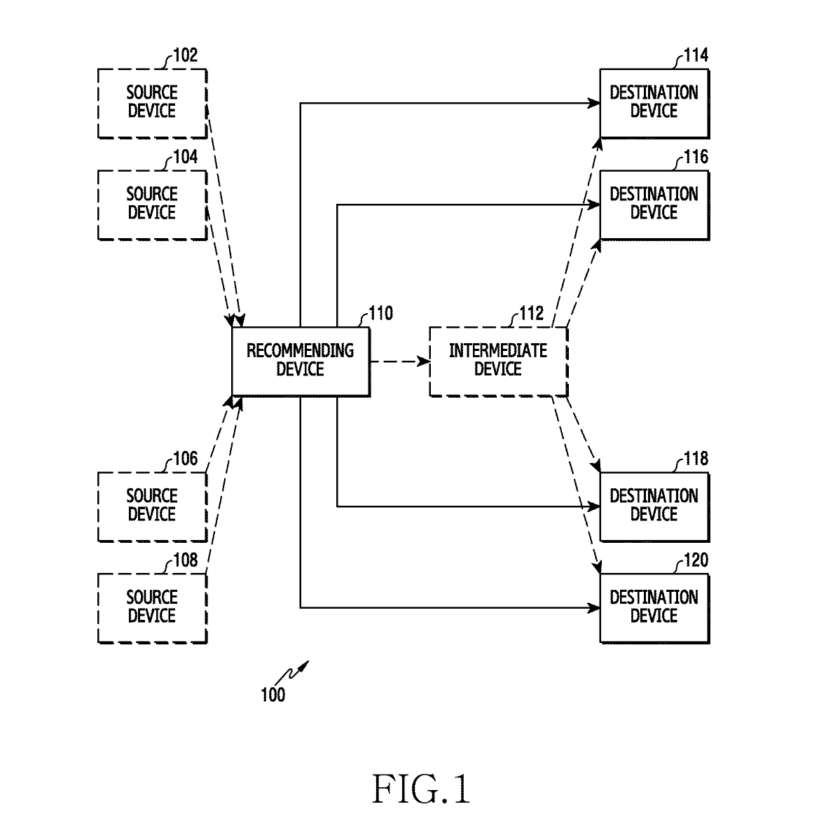

FIG. 1 illustrates a network of interconnected devices in which the method of the present disclosure can be practiced according to an embodiment of the present disclosure.

Referring to FIG. 1, a network 100 of interconnected devices may be provided. The devices can be broadly classified as Source Device(s) 102, 104, 106 and 108, Recommending Device(s) 110, Intermediate Device(s) 112 and Destination Device(s) 114, 116, 118 and 120. Although not specifically illustrated in FIG. 1, it may be further noted that the intermediate device may have a built-in source device or may have a source device connected thereto. It may however, be noted that the network need not always constitute all of the aforesaid types of devices. For example, the Source Device is an optional element in the network. Likewise, the Intermediate Device(s) are optional elements in the network. Also, it is possible wherein two or more devices form part of a single entity. For example, it is possible for the source device and the recommending device to form part of a single entity. Likewise, it is possible for the source device, the recommending device and the intermediate device to form part of a single entity. It is also possible to have a network comprising a single recommending deice and one or more destination devices.

In a network as shown in FIG. 1, the present disclosure enables a recommending device to send a content recommendation relating to broadcast channels, programs, recorded contents, normal copied or computer generated contents to one or more destination devices in network. Copied/computer generated content could be an image, a video, an audio or any document. The recommending method of the present disclosure will be applicable for all shared or protected streaming content stored in a recommending device or a source device connected physically or through a network to the recommending device. Additionally, the recommending method will be applicable for all shared or protected streaming content stored in an intermediate device (or stored with a source device, which is in turn connected to the intermediate device) connected physically or through a network to the recommending device. The recommending method of the present disclosure is suitable for audio visual devices in a home network. Without wishing to be limited, it is believed that the recommending method of the present disclosure is at least suitable for:

A. a recommending device receiving a digital broadcast data (from a source device such as a digital broadcaster) and sending channel recommendation data to one or more destination devices (audio visual devices) in the network.

B. a recommending device (such as a television (TV) or a set top box (STB)) having at least one source device (hard drive or pen drive or compact disc (CD) drive or a personal recorder, etc.) connected to it, can send content recommendation pertaining to a stored or recorded content (as available with the source device) to one or more destination devices in the network.

C. a recommending device (such as an audio visual device/STB) capable of receiving broadcast data (from a first source device such as a digital broadcaster). The recommending device being adapted to store the received broadcast data on a second source device attached thereto (such as personal recorder for recording broadcast channel program/content for watching the same video show at later time). The recommending device being further adapted to send content recommendation pertaining to the recorded content to other audio visual devices in the network.

D. a recommending device (an audio visual device such as a television) with which personal recorder is not integrated for recording broadcast show or which doesn't have any storage device integrated or which doesn't have capability of receiving broadcast data, can also send content recommendation to other connected audio visual devices in the network. After receiving the content recommendation, the destination device, can obtain the content from a server (an intermediate device) which is capable of receiving broadcast channel data or a recorder integrated or internal or external hard drive/pen drive/any storage device integrated with.

E. a recommending device (an audio visual device such as a television) which does not have personal recorder integrated or doesn't have any storage device integrated or doesn't have capability of receiving broadcast data, can also send content recommendation to other connected destination devices in the network. In this case recommending device before sending the content recommendation to destination device, can fetch required recommended content from server (intermediate device) which is capable of receiving broadcast data, has integrated recorder and connected storage device.

F. after receiving the content recommendation on the destination device, when the user of the destination device accepts that recommendation request, streaming of that particular recommended content from either the Source Device or the Recommending Device or the Intermediate Device to Destination Device will start and the user at the Destination Device can then watch that content immediately.

It must however be noted that the claims of the present application are not intended to be restricted to the methods mentioned above. A recommendation can be sent from recommending device to the destination device in the form of a text message, an audio message or a picture representation of the contents.

In the following paragraphs, an elaboration will be provided on various recommending methods which can be implemented in a network, such as that illustrated in FIG. 1. Particularly, the method as performable by each of the recommending device, the intermediate device and the destination device will be described separately.

To start with, various recommending methods which can be implemented by a recommending device (e.g., 110) are described.

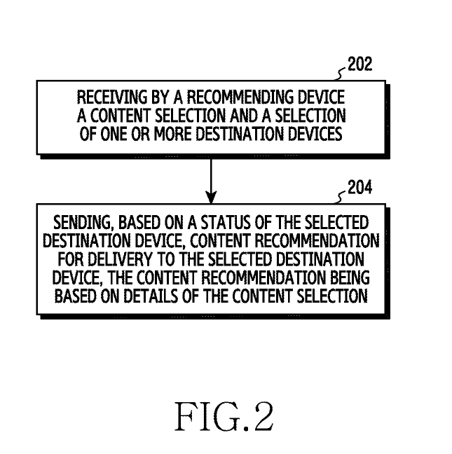

FIG. 2 illustrates a method of sending a content recommendation to one or more destination devices for output thereupon according to an embodiment of the present disclosure.

Referring to FIG. 2, a method of sending a content recommendation to one or more destination devices for output thereupon is provided. The method may include:
receiving, at operation 202, by a recommending device, a content selection and a selection of one or more destination devices, the content selection pertaining to a content available with the recommending device or with a source device connectable to the recommending device; and
sending, at operation 204, based on a status of the selected destination device, content recommendation for delivery to the selected destination device.

In an embodiment of the present disclosure, sending a content recommendation based on information of the content selection comprises sending at least one of a content metadata or a preview data corresponding to the content selection.

In an embodiment of the present disclosure, sending a content recommendation based on information of the content selection comprises sending a customized text message or a customized multimedia message.

In an embodiment of the present disclosure, sending a content recommendation based on information of the content selection comprises sending content metadata and optionally a user provided data.

In an embodiment, the status of the destination device comprises at least one of an “OFF status”, an “ON status” and a “hibernating status”.

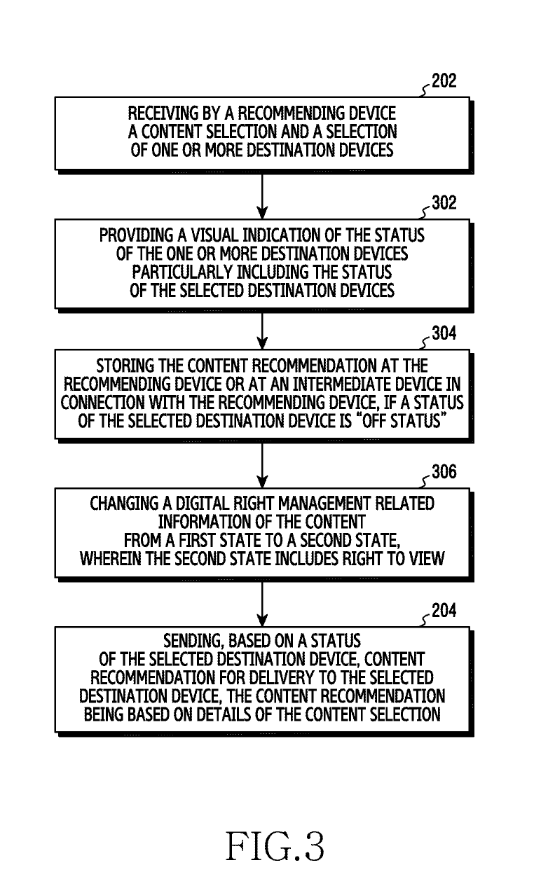

FIG. 3 illustrates a method of sending a content recommendation to one or more destination devices for output thereupon including operations according to an embodiment of the present disclosure.

Referring to FIG. 3, apart from operations of receiving at operation 202 and sending at operation 204, the method as illustrated in FIG. 2, can comprise optional steps. While the method can comprise many operations, it should be noted that it is not essential that all of the operations be performed and the method can incorporate one or any combination of the operations. In a further embodiment of the present disclosure, the method further comprises providing a visual indication of the status of the one or more destination devices at operation 302.

In a further embodiment of the present disclosure, the method 200 comprises providing a visual indication of the status of the selected destination devices at operation 302.

In an embodiment of the present disclosure, the method further comprises storing at operation 304 the content recommendation at the recommending device or at an intermediate device in connection with the recommending device, if a status of the selected destination device is “OFF status”.

In an embodiment of the present disclosure, the method further comprises changing at operation 306 digital right management related information of the content from a first state to a second state, wherein the second state includes a right to view.

In an embodiment of the present disclosure, receiving the content selection at operation 202 comprises receiving information of content, the content being at least one of an ongoing broadcast, a forthcoming broadcast, a multimedia content stored within the recommending device, a multimedia content available with a source device connectable to the recommending device, a webpage content or a file.

In an embodiment of the present disclosure, sending a content recommendation at operation 204 comprises sending at least one of content metadata, broadcast channel metadata, channel information data, preview data corresponding to the content selection, webpage preview data, or file preview data.

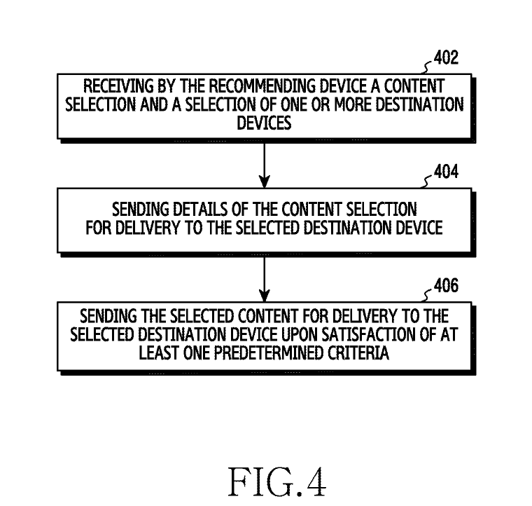

FIG. 4 illustrates yet another method of sending content from a recommending device or a source device to one or more destination devices for outputting thereupon according to an embodiment of the present disclosure.

Referring to FIG. 4, a method for sending content from a recommending device or a source device to one or more destination devices for outputting is illustrated. In an embodiment, the method comprises the following operations.

Receiving at operation 402, by the recommending device, a content selection and a selection of one or more destination devices;

Sending at operation 404 information of the content selection for delivery to the selected destination device; and

Sending at operation 406 the selected content for delivery to the selected destination device based on at least one predetermined criteria.

In an embodiment of the present disclosure, receiving the content selection comprises receiving information of the content, the content being at least one of an ongoing broadcast, a forthcoming broadcast, a multimedia content stored within the recommending device, a multimedia content available with a source device connectable to the recommending device, a webpage content or a file.

In an embodiment of the present disclosure, sending information of the content selection for delivery comprises sending a customized text message or a customized multimedia message.

In an embodiment of the present disclosure, sending information of the content selection comprises sending at least one of content metadata, broadcast channel metadata, channel information data, preview data corresponding to the content selection, webpage preview data, or file preview data.

In an embodiment of the present disclosure, the at least one pre-determined criterion comprises at least one of:
a content viewing acceptance received from the selected destination device; and
availability of the content pertaining to the content selection only at the recommending device or with the source device connectable to the recommending device.

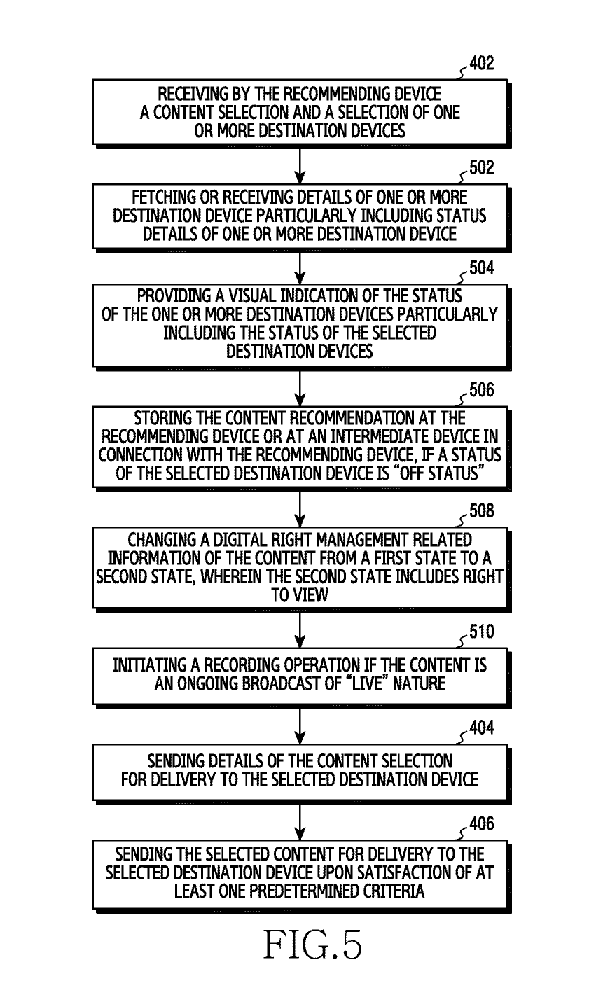

FIG. 5 illustrates yet another method of sending content from a recommending device or a source device to one or more destination devices for outputting thereupon, including operations according to an embodiment of the present disclosure.

Referring to FIG. 5, the method illustrated in FIG. 4 can comprise of additional operations. While the method can comprise many operations, it should be noted that it is not essential that all of the operations be performed and the method can incorporate one or any combination of the optional operations.

In an embodiment of the present disclosure, the method further comprises fetching or receiving at operation 502, by the recommending device, information of one or more destination device and more particularly, fetching or receiving, by the recommending device, status information of one or more destination device.

In an embodiment of the present disclosure, the method further comprises providing at operation 504 a visual indication of the status of the one or more destination devices and more particularly, providing a visual indication of the status of the selected destination devices.

In an embodiment of the present disclosure, sending information of the content selection for delivery to the selected destination device is based on a status of the selected destination device.

In an embodiment of the present disclosure, if a status of the selected destination device is “OFF status”, storing at operation 506 the information of the content selection at the recommending device or at an intermediate device till the status changes to any one of “ON status” or “hibernating status”.

In a further embodiment of the present disclosure, the method further comprises changing at operation 508 digital right management related information of the multimedia content from a first state to a second state, wherein the second state includes a right to view.

In an embodiment of the present disclosure, the method further comprises prior to sending the selected content, initiating at operation 510 a recording operation if the content is an ongoing broadcast of “LIVE” nature. This aspect may be preferentially used if the destination device is in OFF state or in hibernating state.

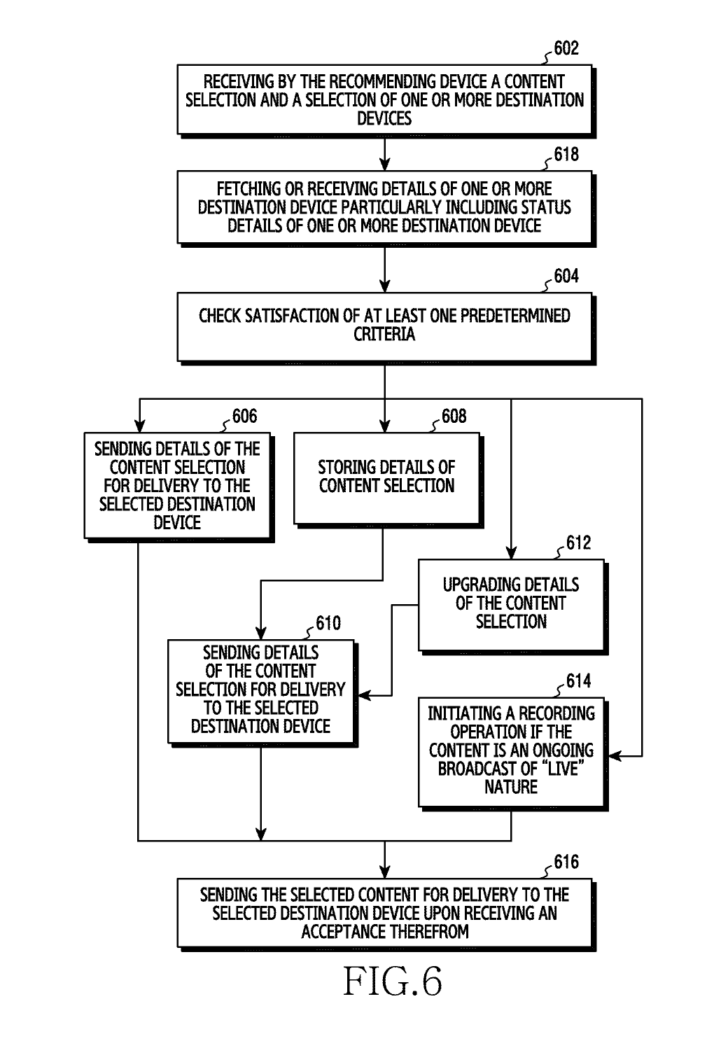

FIG. 6 illustrates a method for sending content from a recommending device to one or more destination devices including optional operations, wherein the recommending device and the destination device are part of a home network environment according to an embodiment of the present disclosure.

Referring to FIG. 6, a method for sending content from a recommending device to one or more destination devices, the recommending device and the destination device being part of a home network environment, is provided. The method may include the following operations.

Receiving at operation 602, by the recommending device, a content selection and a selection of one or more destination devices;

Performing, based on at least one predetermined criteria at operation 604, any one of:
sending information of the content selection for delivery to the selected destination device at operation 606;
storing information of the content selection at operation 608 for a delayed delivery at operation 610 to the selected destination device;
upgrading information of the content selection at operation 612 at the time of delayed delivery at operation 610 to the selected destination device; or
initiating a recording at operation 614 if the content is an ongoing broadcast of “LIVE” nature; and
sending the selected content at operation 616 for delivery to the selected destination device upon receiving an “acceptance” therefrom.

In an embodiment of the present disclosure, receiving the content selection comprises receiving information of content, the content being at least one of an ongoing broadcast, a forthcoming broadcast, a multimedia content stored within the recommending device, a multimedia content available with a source device connectable to the recommending device, a webpage content or a file.

In an embodiment of the present disclosure, sending information of the content selection for delivery comprises sending a customized text message or a customized multimedia message.

In an embodiment of the present disclosure, sending information of the content selection comprises sending at least one of a content metadata, a broadcast channel metadata, channel information data, or a preview data corresponding to the content selection.

In an embodiment of the present disclosure, the at least one pre-determined criterion comprises at least one of:
a status of the destination device; and/or
a relevancy of the information of the content selection at the time of delayed delivery.

In an embodiment of the present disclosure, the method further comprises fetching or receiving, by the recommending device, information of one or more destination device and more particularly, fetching or receiving, by the recommending device, status information of one or more destination device at operation 618.

In an embodiment of the present disclosure, upgrading information of the content selection includes upgrading the information of the content selection based on forthcoming broadcast related information (electronic program guide (EPG) data).

Hereinafter, an exemplified internal configuration of a recommending device 110 for performing the above described recommending methods will be described with reference to the accompanying figures.

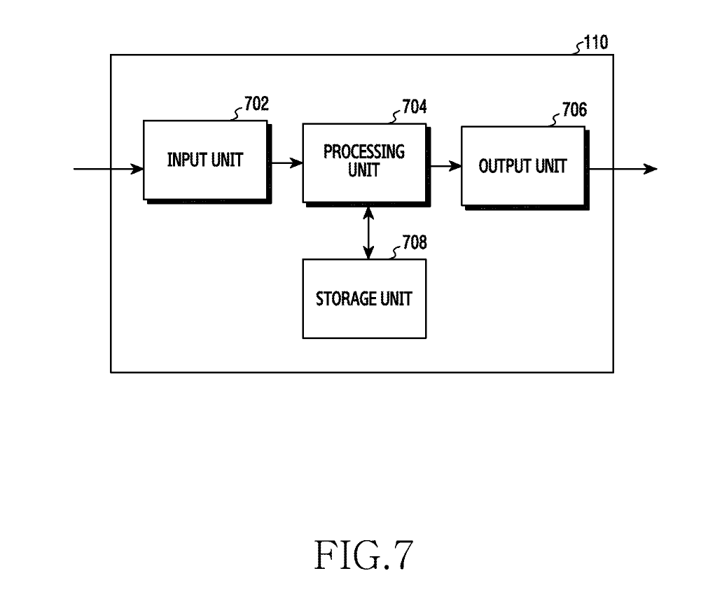

FIG. 7 illustrates a recommending device for sending a content recommendation to one or more destination devices according to an embodiment of the present disclosure.

Referring to FIG. 7, the recommending device 110 for sending a content recommendation to one or more destination devices for outputting thereupon comprises an input unit 702 for receiving a content selection and a selection of one or more destination devices, the content selection pertaining to a content available with the recommending device or with a source device connectable to the recommending device, and a processing unit 704 coupled with an output unit 706 for sending, based on a status of the selected destination device and information of the content selection, a content recommendation for delivery to the selected destination device.

In an embodiment of the present disclosure, the processing unit 704 is configured to include in the content recommendation at least one of a content metadata or a preview data corresponding to the content selection.

In an embodiment of the present disclosure, the processing unit 704 is configured to include in the content recommendation a customized text message or a customized multimedia message.

In an embodiment of the present disclosure, the processing unit 704 is configured to include in the content recommendation a content metadata and optionally a user provided data.

In an embodiment of the present disclosure, the status of the destination device comprises at least one of an “OFF status”, an “ON status” and a “hibernating status”.

In a further embodiment of the present disclosure, the processing unit 704 is adapted to provide a visual indication of the status of the one or more destination devices. Particularly, the processing unit 704 is adapted to provide a visual indication of the status of the selected destination devices.

In a further embodiment of the present disclosure, the recommending device 110 further comprises a storage unit device 708 for storing the content recommendation at the recommending device, if a status of the selected destination device is “OFF status”. Alternatively, the processing unit 704 is adapted to enable storage of the content recommendation at an intermediate device, if the status of the selected destination device is “OFF status”. The storage device may be further adapted to store the content, for example, if the content is a “LIVE” content and if the destination device is in OFF status or in hibernating status.

In an embodiment of the present disclosure, the processing unit 704 is further adapted to changing a digital right management related information of the content from a first state to a second state, wherein the second state includes a right to view. Alternatively, the processing unit 704 is further adapted to request for changing a digital right management related information of the content from a first state to a second state, wherein the second state includes a right to view.

In an embodiment of the present disclosure, the input unit 702 is further adapted to receiving information of a content, the content being at least one of an ongoing broadcast, a forthcoming broadcast, a multimedia content stored within the recommending source device, a multimedia content available with a source device connectable to the recommending device, a webpage content or a file.

In an embodiment of the present disclosure, the output unit 706 is further adapted to sending at least one of a content metadata, a broadcast channel metadata, channel information data, a preview data corresponding to the content selection, a webpage preview data, or a file preview data.

As per an embodiment of the present disclosure, which is also being described with the help of FIG.7, the recommending device 110 for sending content to one or more destination devices for outputting comprises:
an input unit 702 for receiving a content selection and a selection of one or more destination devices; and
a processing unit 704 coupled with an output unit 706 for:
   sending information of the content selection for delivery to the selected destination device; and
   sending the selected content for delivery to the selected destination device based on at least one predetermined criteria.

In an embodiment of the of the present disclosure, the input unit 702 is adapted to receiving information of the content, the content being at least one of an ongoing broadcast, a forthcoming broadcast, a multimedia content stored within the recommending device, a multimedia content available with a source device connectable to the recommending device, a webpage content or a file.

In an embodiment of the present disclosure, the processing unit 704 and the output unit 706 are adapted to sending a customized text message or a customized multimedia message.

In an embodiment of the present disclosure, processing unit 704 and the output unit 706 are adapted to sending at least one of a content metadata, a broadcast channel metadata, channel information data, a preview data corresponding to the content selection, a webpage preview data, or a file preview data.

In an embodiment of the present disclosure, the at least one pre-determined criterion comprises at least one of:
a content viewing acceptance received from the selected destination device; and
availability of the content pertaining to the content selection only at the recommending device or with the source device connectable to the recommending device.

In a further embodiment of the present disclosure, the input unit 702 is further adapted to fetching or receiving information of one or more destination device and more particularly, fetching or receiving by the recommending device status information of one or more destination device.

In an embodiment of the present disclosure, the processing unit 704 is further adapted to providing a visual indication of the status of the one or more destination devices and more particularly, providing a visual indication of the status of the selected destination devices.

In an embodiment of the, the processing unit 704 and the output unit 706 are adapted to send information of the content selection for delivery to the selected destination device based on a status of the selected destination device.

In an embodiment of the present disclosure, the recommending device further comprises a storage device 708 for storing the information of the content selection if a status of the selected destination device is “OFF status” and till the status changes to any one of “ON status” or “hibernating status”. Alternatively, the recommending device is further adapted to enable storing of the information of the content selection at an intermediate device if a status of the selected destination device is “OFF status” and till the status changes to any one of “ON status” or “hibernating status”. In a further embodiment, the recommending device is further adapted to store content, especially when the content is LIVE content and the destination device is in OFF state or in hibernating state. The content can be stored either in the storage device 708 or at the source device or at the intermediate device. In the aforesaid case, the source device can be either connected to the recommending device or to the intermediate device.

In an embodiment of the present disclosure, the processing unit 704 is further adapted to changing a digital right management related information of the multimedia content from a first state to a second state, wherein the second state includes a right to view. Alternatively, the processing unit 704 is further adapted to request for changing a digital right management related information of the content from a first state to a second state, wherein the second state includes a right to view.

In an embodiment of the present disclosure, the recommending device further comprises a recording device for performing a recording operation under the instruction of the processing unit 704, for example including a scenario wherein the content is an ongoing broadcast of “LIVE” nature. Alternatively, the processing unit 704 is further adapted to request a recording device for recording a content, for example including a scenario wherein the content is an ongoing broadcast of “LIVE” nature.

It may be thus noticed that while the internal configurations of the recommending device as per the above embodiment may be substantially identical to the internal configurations of the recommending device as per the previously described embodiment, their functions can be different.

As per an embodiment of the present disclosure which is also being described with the help of FIG. 7, the recommending device 110 for sending content to one or more destination devices for outputting comprises:
an input unit 702 for receiving a content selection and a selection of one or more destination devices; and
a processing unit 704 coupled with an output unit 706 for performing, based on at least one predetermined criteria, any one of:
   sending information of the content selection for delivery to the selected destination device;
   storing information of the content selection for a delayed delivery to the selected destination device;
   upgrading information of the content selection at the time of delayed delivery to the selected destination device; or
   initiating a recording operation if the content is an ongoing broadcast of “LIVE” nature; and
the processor unit 704 being further adapted to send the selected content for delivery to the selected destination device upon receiving an “acceptance” therefrom.

In an embodiment of the present disclosure, the input unit 702 is adapted to receiving information of a content, the content being at least one of an ongoing broadcast, a forthcoming broadcast, a multimedia content stored within the recommending device, a multimedia content available with a source device connectable to the recommending device, a webpage content or a file.

In an embodiment of the present disclosure, the processing unit 704 and the output unit 706 are adapted to sending a customized text message or a customized multimedia message.

In an embodiment of the present disclosure, the processing unit 704 and the output unit 706 are adapted to sending at least one of a content metadata, a broadcast channel metadata, channel information data, or a preview data corresponding to the content selection.

In an embodiment of the present disclosure, the at least one pre-determined criteria comprises at least one of:
a status of the destination device; and/or
a relevancy of the information of the content selection at the time of delayed delivery.

In an embodiment of the present disclosure, input unit 702 is further adapted to fetching or receiving information of one or more destination device, and more particularly, to fetching or receiving status information of one or more destination device.

In an embodiment of the present disclosure, the processing unit 704 is further adapted to upgrading the information of the content selection based on forthcoming broadcast related information EPG data.

In the following paragraphs, the method as may be performed by an intermediate device 112 (in case the intermediate device is a separate component of the overall system) will be described in more detail.

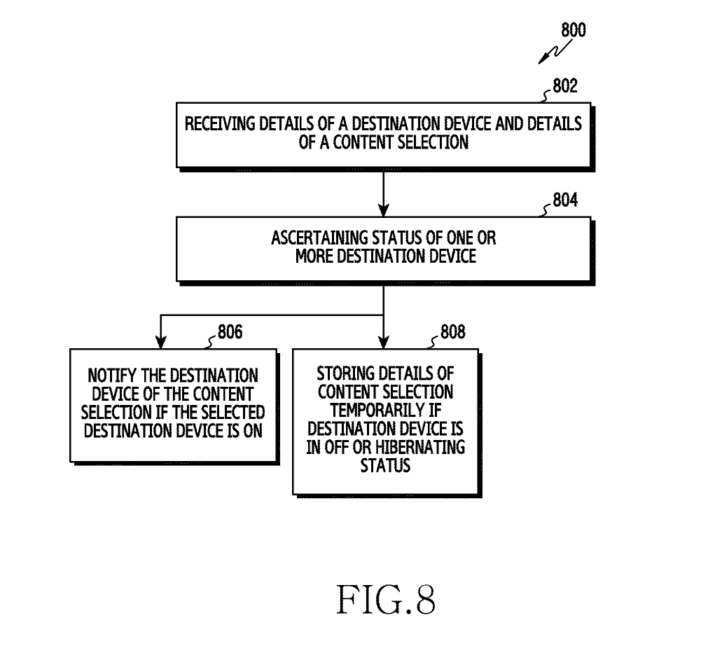

FIG. 8 illustrates a method of assisting transmission of content from a recommending device to one or more destination devices for outputting, the method being adapted to be performed by an intermediate device according to an embodiment of the present disclosure.

Referring to FIG. 8, there is provided a method of assisting transmission of content from a recommending device to one or more destination devices for outputting, the method being adapted to be performed by an intermediate device 112 and comprising the operations of:
receiving at operation 802, by an intermediate device operably connected to the recommending device, information of a destination device and information of content selection; and
identifying at operation 804 a status of the destination device and performing at least one of:
notifying at operation 806 the destination device the information of content selection, if the destination device is in an ON status; and
storing at operation 808 the information of content selection temporarily if the destination device is in a hibernating status or an OFF status.

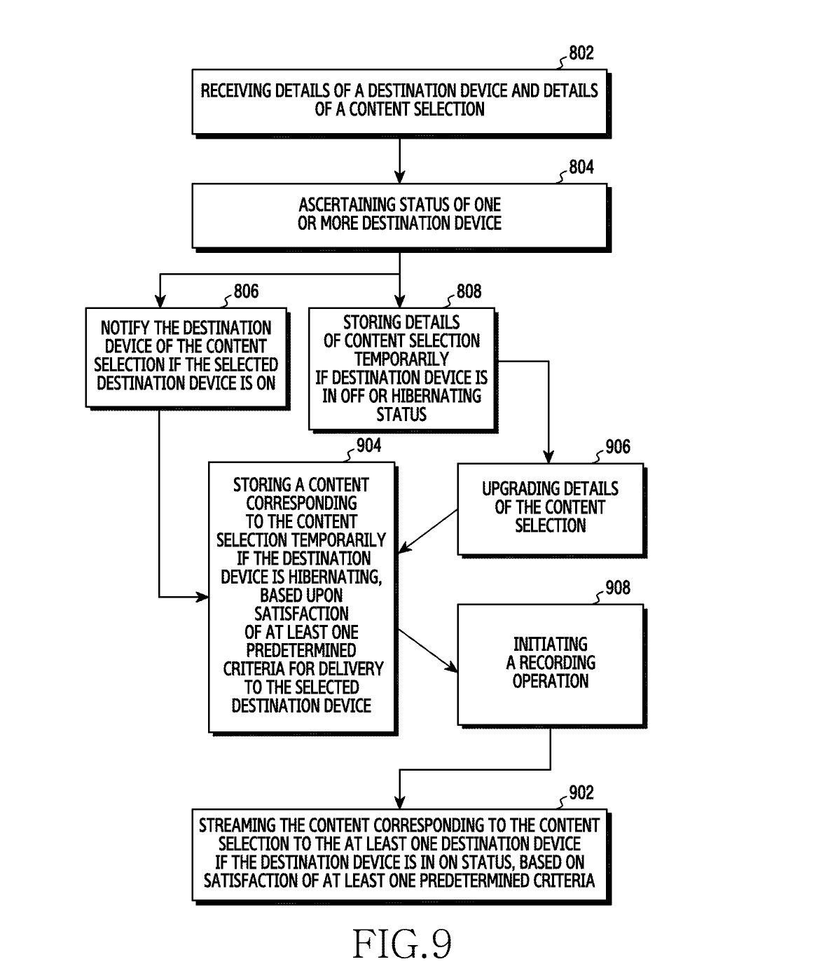

FIG. 9 illustrates a method of assisting transmission of content from a recommending device to one or more destination devices for outputting, the method being adapted to be performed by an intermediate device according to an embodiment of the present disclosure.

Referring to FIG. 9, the method of FIG. 8 can comprise of optional operations. While the method can comprise many optional operations, it should be noted that it is not essential that all of the optional operations be performed and method can comprise incorporate one or any combination of the operations. In an embodiment of the present disclosure, the method further comprises streaming at operation 902 a content corresponding to the content selection to the at least one destination device if the destination device is in an ON status, based upon at least one predetermined criteria.

In an embodiment of the present disclosure, the at least one pre-determined criteria comprises at least one of:
receiving a content viewing acceptance from the selected destination device; and
availability of the content corresponding to the content selection at the intermediate device.

In an embodiment of the present disclosure, the method further comprises:
storing at operation 904 a content corresponding to the content selection temporarily if the destination device is in hibernating status and if the content is LVE content, based upon satisfaction of at least one predetermined criterion; and
streaming the content at operation 902 corresponding to the stored information of content selection to the destination device, based upon determining a transition in status of the destination device from a hibernating status to an ON status and receipt of a content viewing acceptance from the selected destination device.

In an embodiment of the present disclosure, the method further comprises upgrading information of the content selection at operation 906 at the time of notifying to the selected destination device.

In an embodiment of the present disclosure, the method further comprises initiating a recording operation at operation 908.

Hereinafter, an exemplified internal configuration of the intermediate device 112 for performing the above described recommending methods will be described with reference to the accompanying figures.

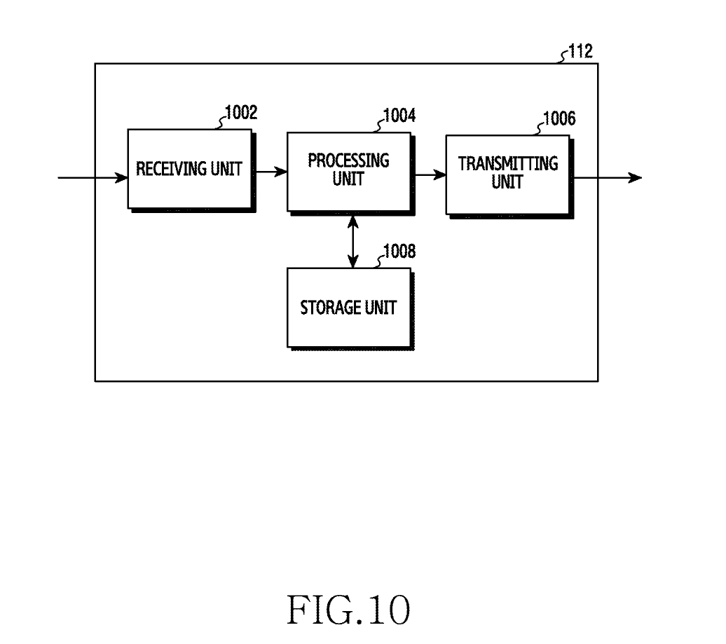

FIG. 10 illustrates a construction of an intermediate device according to an embodiment of the present disclosure.

Referring to FIG. 10, the intermediate device 112 comprises:
a receiving unit 1002 for receiving from at least one recommending device, information of a destination device and information of content selection;
a processing unit 1004 identifying a status of the destination device,
a transmitting unit 1006 being in operational interconnection with the processing unit 1004 for notifying the destination device the information of content selection, if the destination device is in an ON status; and
a storage device 1008 being in operational interconnection with the processing unit 1004 for storing the information of content selection temporarily if the destination device is in a hibernating status or an OFF status.

In an embodiment of the present disclosure, the processing unit 1004 and the transmitting unit 1006 are further adapted to streaming a content corresponding to the content selection to the at least one destination device if the destination device is in an ON status, based upon at least one predetermined criteria.

In an embodiment of the present disclosure, the at least one pre-determined criterion comprises at least one of:
receiving a content viewing acceptance from the selected destination device; and
availability of the content corresponding to the content selection at the intermediate device.

In an embodiment of the present disclosure, the processing unit 1004 and the storage unit 1008 are further adapted to storing a content corresponding to the content selection temporarily if the destination device is in hibernating status, based upon at least one predetermined criteria and the processing unit 1004 and the transmitting unit 1006 are further adapted to streaming the content corresponding to the stored information of content selection to the destination device, based upon determining a transition in status of the destination device from a hibernating status to an ON status and receipt of a content viewing acceptance from the selected destination device.

In an embodiment of the, the processing unit 1004 is further adapted to upgrading information of the content selection at the time of notifying to the selected destination device.

In an embodiment of the present disclosure, the processing unit 1004 is further adapted to initiating a recording operation.

In the following paragraphs, a method as may be performed by a destination device 114, 116, 118 or 120 will be described in more detail.

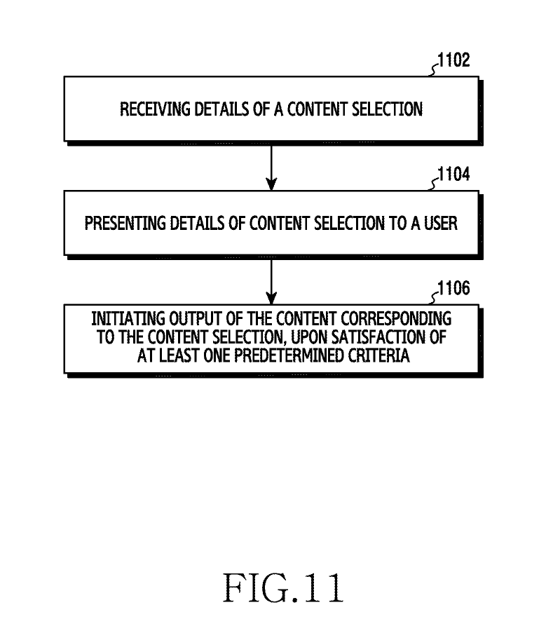

FIG. 11 illustrates a method adapted to be performed by a destination device for assisting transmission of content from a recommending device to one or more destination devices for outputting according to an embodiment of the present disclosure.

Referring to FIG. 11, there is provided a method of assisting transmission of content from a recommending device to one or more destination devices for outputting, the method being adapted to be performed by a destination device 114, 116, 118 or 120 and comprising the operations of:
receiving at operation 1102, by a destination device, information of content selection;
presenting at operation 1104, by the destination device, the information of content selection to a user; and
initiating at operation 1106, by the destination device, output of the content corresponding to the information of content selection to the user upon satisfaction of at least one predetermined criteria.

In an embodiment of the present disclosure, the presenting comprises transforming the information of the received content selection to a format comprising one or more of an audio format, a text format, and a video format and a graphic overlay.

In an embodiment of the present disclosure, the initiating comprises rendering, by the destination device, output of the content corresponding to the information of content selection to the user in a selected mode, the mode comprising one or more of a full screen display, video overlay and a picture-in-picture (PIP) format.

In an embodiment of the present disclosure, rendering comprises accessing the content selection corresponding to at least one of the stored content or a broadcast content.

In an embodiment of the present disclosure, the stored content is accessed from at least one of the recommending device or an intermediate device.

In further embodiment of the present disclosure, the predetermined condition includes receiving an acceptance from the user for initiating output of the content.

Hereinafter, an exemplified internal configuration of the destination device 114, 116, 118 or 120 for performing the above described recommending methods will be described with reference to the accompanying figures.

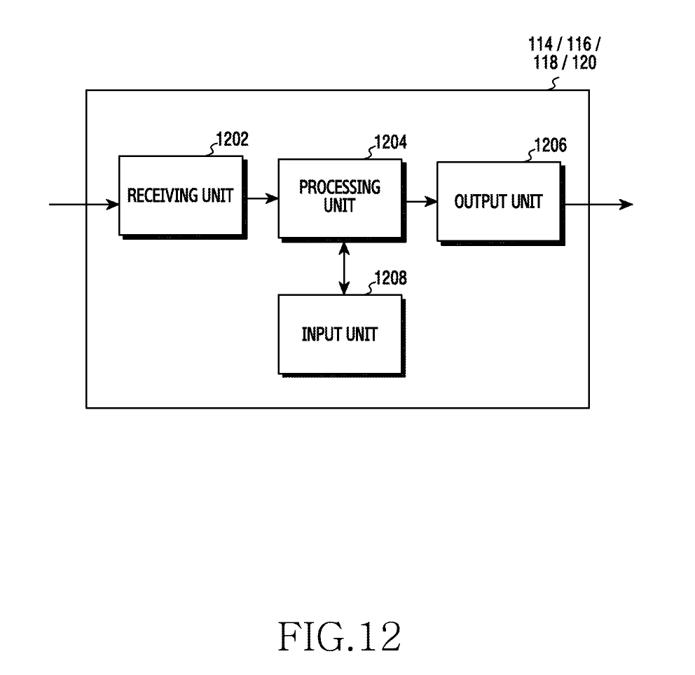

FIG. 12 illustrates a construction of a destination device according to an embodiment of the present disclosure.

Referring to FIG. 12, the destination device 114, 116, 118 or 120 comprises:
a receiving unit 1202 for receiving information of content selection;
a processing unit 1204 operatively coupled to an output unit 1206 for presenting the information of content selection to a user and prompting the user to provide an acceptance for initiating output of the content; and
an input unit 1208 for receiving an input from the user;
the processing unit 1204 and the receiving unit 1202 being adapted to receive a content corresponding to the content selection; and
the processing unit 1204 and the output unit 1206 being adapted to output the content corresponding to the information of content selection to the user.

In an embodiment of the present disclosure, the processing unit 1204 is further adapted to transforming the information of the received content selection to a format comprising one or more of an audio format, a text format, and a video format and a graphic overlay.

In an embodiment of the present disclosure, the processing unit 1204 and the output unit 1206 are further adapted to rendering, output of the content corresponding to the information of content selection to the user in a selected mode, the mode comprising one or more of a full screen display, a video overlay and a picture-in-picture (PIP) format.

In an embodiment of the present disclosure, the processing unit 1204 is further adapted to accessing the content selection corresponding to at least one of the stored content or a broadcast content.

In an embodiment of the present disclosure, the processing unit 1204 is further adapted to access the stored content from at least one of the recommending device or an intermediate device.

In a further embodiment of the present disclosure, the predetermined condition includes receiving an acceptance from the user for initiating output of the content.

While in the above paragraphs, the disclosure in terms of the method as performed by the individual components and the detailed construction of each individual component has been described, for enabling ease of understanding, an overall view is being provided in the following paragraphs. Also, in some of the places, to promote ease of understanding, specific network configuration such as a home network configuration might have been taken. However, it must be understood that the scope of the present disclosure is not intended to be restricted to the following description, which as stated above is provided merely for the purposes of enabling an ease in understanding and the scope of the present disclosure is intended to be restricted only by the contents of the claims and their equivalence.

With rapid expansion of streaming technology and streamer server in home network, now using protocol like digital living network alliance (DLNA), universal plug and play (UPnP), digital living network alliance commercial video profile (DLNA CVP2), remote user interface (RUI) and R-view (RVU) etc., user can have a home network setup comprising 2 or more audio visual device or television client and only one server, wherein the single server can be capable of receiving broadcast signal, can have an integrated personal recorder in order to record a video content for watching broadcast show or video at a later time, can have integrated internal hard drive or can have hardware support to attach external storage device (like hard drive or pen drive etc.) to connect physically or can be connected in network. Now all clients in that home network can stream same or different content, store computer generated copied content from internal or external hard drive of server and also can stream same or different LIVE broadcast content from the server. At client end, user can watch those stream contents on their audio visual device. So it is a shared setup for home network where we may only have one server. Server can support number of streaming content based on network bandwidth and also can support number of broadcast content streaming based on available physical tuner attached with the server. Apart from the above, in Home Network 2 of more users can use same storage device connected physically or connected through network at the same time.

If USER A has recently added/recorded 10 video/image/audio/document contents in a storage device that may be connected with USER A television or in server (television (TV)/set top box (STB)) and out of 10 USER A found 1 recorded/copied video/image/audio/document very useful for USER B, so USER A can send recommendation to USER B directly. In this case USER B doesn't need to check every recorded/copied video/image/audio/document that USER A has recently added or recorded in the storage device to find the useful content. Also for USER B this could be very difficult to find the actual recorded/copied video/image/audio content if there are many video/audio/image/document content present in the storage device connected physically or through network with server.

Some of the LIVE broadcast contents are not always available, once it finishes broadcasting. So in home network while watching a broadcast video content on television, USER A can recommend other users in the same network, by giving them the video channel data information. So if USER B will not miss watching that particular broadcast content at particular time.

Thus, one can say that the present disclosure enables content recommendations in a network of connected devices including for example, a home network. Although not being restricted, the present disclosure particularly enables content recommendations to be sent relating to broadcast channels, programs, recorded contents, normal copied or computer generated contents in a home network. The normal copied or computer generated content can be image, video, audio, or any other document.

An aspect of the present disclosure is to provide for sending television channel recommendation from a recommending device to a destination device, wherein the information of the destination device are known to a user of the recommending device, which is possible, for example, in a home network environment. The user of the recommending device, which viewing a specific channel on the recommending device, can send a recommendation message for the same channel or for a different channel to at least one destination device which is connected to the network environment.

An aspect of the present disclosure is to provide for sending recommendation for computer generated content from a recommending device to at least one destination device. The computer generated content, can be an image or an audio or a video or a document. By way of a non-limiting example, a user while viewing content at his device can send a recommendation message to one or more destination devices for viewing the same or different computer generated content. The computer generated content may be inherently available at the recommending device or can be available for example, in an external hard drive or pen drive connected to the recommending device. Alternatively, the content may be currently accessed by the recommending device, for example, from internet to which the recommending device may be connected. Alternatively, the content may be available at a shared external hard drive or shared pen drive or a shared server or a memory device connected to the shared server. Alternatively, the content may be available with the intermediate device or with an external hard drive or pen drive connected to the intermediate device.

An aspect of the present disclosure is to provide for sending a recommendation message corresponding to a personal recorder generated recorded content to one or more destination devices in the network. A user while viewing a specific recorded content in his/her audio visual device, can send the same viewing or different recorded content recommendation to one or more destination devices connected in the network. The personal recorder generated recorded content can be accessed from an external hard drive or pen drive connected to recommending device or can be accessed from a shared external hard drive or shared pen drive or an internal hard drive connected to a server to which the recommending device is connected or from the intermediate device or from an external hard drive or pen drive connected to the intermediate device.

An aspect of the present disclosure is to provide for sending a recommendation message pertaining to protected or shared computer generated or recorded content to one or more destination devices in the network. If a recommendation device sends recommendation for a protected content to one or more destination devices in the network, that content will automatically become shared for that destination device and that particular destination device after receiving the recommendation from the recommending device can start streaming of that content and view/watch it.

An aspect of the present disclosure is to provide for an intermediate device such as a server to internally stores content recommendation information (content metadata, originator information, destination client information etc.) into database, if the destination device intended to receive the content recommendation message is in switched OFF mode or in hibernating mode. Alternatively, the recommending device the present disclosure provides for the recommending device to internally stores content recommendation information (content metadata, originator information, destination client information etc.), if the destination device intended to receive the content recommendation message is in switched OFF mode or in hibernating mode.

An aspect of the present disclosure is to provide for the intermediate device, such as a server, to send one or more stored content recommendation messages to the corresponding destination device once the destination device is switched ON. Alternatively, the present disclosure provides for the recommending device to send one or more stored content recommendation messages to the corresponding destination device once the destination device is switched ON.

An aspect of the present disclosure is to provide for deletion of stored content recommendation message, once the same has been delivered to the appropriate destination device. In a preferred aspect, such an action of deleting the stored content recommendation message can be undertaken automatically.

An aspect of the present disclosure is to provide for the recommending device to enable recording of content. The above recording can be enabled under a plurality of circumstances including for example, a circumstance wherein the recommending device has sent a channel content recommendation message to a destination device, which is currently in switched OFF state or in hibernating state. Yet another circumstance wherein the recommending device has sent a channel content recommendation message to a destination device which is currently switched ON, and shows interest in viewing the content after certain amount of time period. In yet another example, the recommending device enables recording of content if the content is of interest to the recommending device and does not place emphasis on the identification of a destination device. This enables the content to be recorded and to be shared subsequently, once a destination device has been subsequently identified. It may be however, noted that the above provided examples are merely for the purpose of illustration and are not intended to restrict the scope of the present disclosure. In still another aspect, the present disclosure provides for the intermediate device to enable recording of content. This aspect of the present disclosure can be helpful in case the recommending device is not having the capability of recording the content or in case a recording device is not directly connected to the recommending device. The above recording can be enabled under any of the plurality of circumstances as explained above. In a further another aspect, the present disclosure provides for the applying of appropriate digital rights management (DRM) parameters to the record content and storing the recorded content along with the DRM parameters.

In an aspect of the present disclosure, the recommending device can enable setting of options such as forceful display of the recommended content or a non-forceful display of the recommended content at the destination device. These options can be chosen at the time of sending the content recommendation message. If a content recommendation message is sent and the option pertaining to forceful display of the recommended content is chosen, the recommended content will be displayed on the destination device. While such forceful display of the content can still be regulated, for example, the display can be in the form of preview, PIP configurations, etc., the recommended content is displayed on the destination device. In case the content recommendation message is sent and the option pertaining to forceful display of the recommended content is chosen, the same can also trigger immediate streaming and/or storing of the recommended content. On the other hand, if the content recommendation message is sent and the option pertaining to non-forceful display of the recommended content is chosen, the destination device can allow the user to opt for not displaying the recommended content. In such a scenario, the destination device can, under the control of the user of the destination device, avoid immediate display of the recommended content.

An aspect of the present disclosure is to enable for the content recommendation message or the recommended content to be displayed by the destination device in various forms, including for example, an overlay form, a preview form, a PIP form, etc. These options can be selected by a user of the destination device and can be elected to over-ride the options as may be contained in the content recommendation message. Thus, based on the options as may be selected by the user, the destination device, after receiving a content recommendation message and/or a recommended content, can display the content recommendation message and/or a recommended content in the appropriate form as per the pre-stored configuration.

An aspect of the present disclosure is to enable the recommending device to allow the user of the recommending device to personalize the content recommendation message. For example, the recommendation device allows a user of the recommendation device to add text message or image or any other multimedia message so as to form part of the content recommendation message. In case, the user of the recommendation device opts to undertake such personalization, the recommendation device captures the appropriate input from the user, automatically forms a personalized content recommendation message and sends the personalized content recommendation message for delivery to the destination device. The recommendation device can allow the user to input the personalized message using any of the user interface devices for example, a user input device such as a remote or a mobile, etc. In the above instance, the destination device is also appropriately configured to receive the personalized message and display such personalized message to the user of the destination device.

An aspect of the present disclosure is to enable the recommending device to allow the user of the recommending device to add small picture image of the channel icon along with the content recommendation message instead of sending channel information. The configuration can be such that once the user accepts the content recommendation message, the appropriate content can the automatically displayed on the destination device.

An aspect of the present disclosure is to enable the recommendation device to send content metadata optionally along with small picture image of the content icon or thumbnail as part of the content recommendation message. This aspect can be beneficially implemented in case of copied content.

An aspect of the present disclosure is to enable the recommendation device to send program metadata optionally along with small picture image of the program icon or thumbnail of the program as part of the content recommendation message. This aspect can be beneficially implemented while sending content recommendation message pertaining to broadcast channel content.

An aspect of the present disclosure is to enable the recommendation device to send content recommendation message to the destination device in the form of text message, audio message or picture representation of the contents. Thus, for example, the recommendation device can capture audio clip as may be provided by the user or can convert as provided by the user a text and include the same as part of the content recommendation message. Likewise, the recommendation device can receive a picture from the user or choose a picture to be included as part of the content recommendation message.

An aspect of the present disclosure is to enable the recommendation device to modify the content recommendation message of the subsequent to its creation and prior to sending the same for delivery to the destination device. This aspect can be beneficially used in case the content recommendation message is being stored for any of the reasons as provided above. By way of example, if the content corresponding to the content recommendation message is not available because of time expiry, the content recommendation message can be modified, to update a revised time as to when the content would be available. By way of yet another example, if the content recommendation message can be modified to provide an update with regard to the source of the recommended content, if for instance there has been a change in the source of the recommended content (which can happen for example, in case of a recorded content).

An aspect of the present disclosure is to enable the intermediate device to modify the content recommendation message which has been temporarily stored prior to sending the same for delivery to the destination device. This aspect can be beneficially used in case the content recommendation message is being stored for any of the reasons as provided above. By way of example, if the content corresponding to the content recommendation message is not available because of time expiry, the content recommendation message can be modified, to update a revised time as to when the content would be available. By way of yet another example, if the content recommendation message can be modified to provide an update with regard to the source of the recommended content, if for instance there has been a change in the source of the recommended content (which can happen for example, in case of a recorded content).

An aspect of the present disclosure is to enable the recommending device and/or the intermediate device to undertake the modification of the content recommendation message based on data as may be available with it, for example, EPG data.

An aspect of the present disclosure is to enable an intermediate device or a recommending device to allow a destination device to access the content corresponding to a content recommendation message, after a substantial time delay. Such option can be beneficially implemented, for example, in respect of video on demand, wherein the destination device can access the recommended content after a substantial time delay and the source of the recommended content, will allow for a dedicated reception of the content by the destination device.

It will be further appreciated that the same scenario can be applied to LIVE streaming of broadcast channels. Suppose USER A is watching an important program which has just started on AXN channel and USER A is watching the same on a recommending device, in case USER A believes that the news program is of interest or help to USER B (who may or may not watching the program), the recommending device enables USER A to send out a content recommendation message to be delivered to a destination device accessed by USER B.

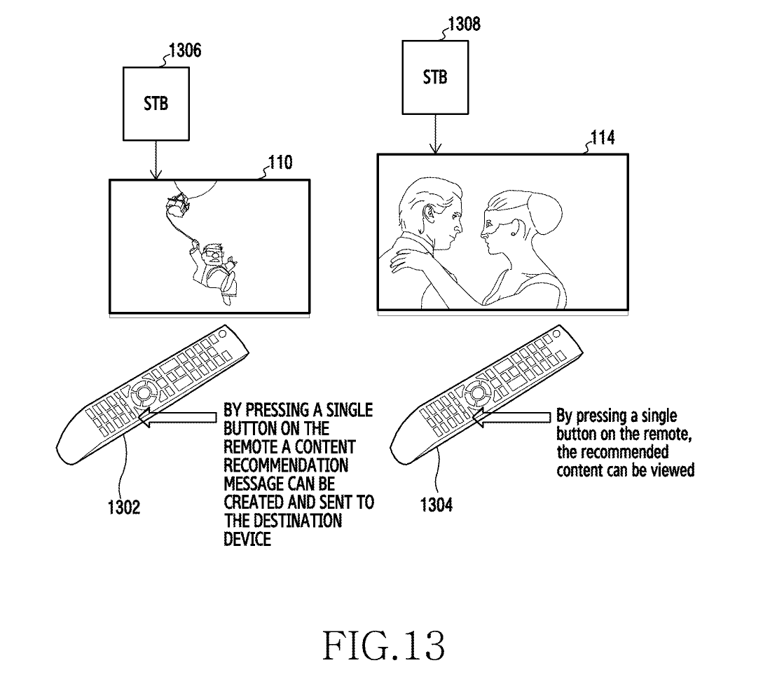

FIG. 13 illustrates a scenario wherein a recommending device is able to receive a recommendation message even in the form of a single press of a button from a remote control device and similarly a destination device is able to receive the content on a single press of a button from a remote control device according to an embodiment of the present disclosure.

Referring to FIG. 13, the present disclosure enables a recommending device 110 to receive a recommendation message even in the form of a single press of a button from a remote control device at operation 1302 which may be available with USER A or on the basis of a voice command as provided by the USER A or on the basis of a gesture command as provided by USER A and on the basis of the same, send a recommendation message as “Recommendation from USER A: Channel No: 501, Channel: AXN, Program: Oscar Award Show Duration: 8:30 PM To 10:30 PM” to a destination device 114 which is being accessed by USER B. The present disclosure furthermore enables the destination device 114 to receive an acceptance to view the recommended content even in the form of a single press of a button from a remote control device at operation 1304 which may be available with USER B and on the basis of the same, change the channel from the currently viewed channel to the recommended channel, start streaming the content of the recommended channel and output the recommended channel. As demonstrated in FIG. 13, it is feasible in this case that each of the recommending device 110 and the destination device 114 are connected to their respective STBs at operations 1306 and 1308 and are connected to each other in a peer to peer configuration, wherein depending upon circumstances, one of the device can function as a master device. It may however, be noted that it is not mandatory that each of the recommending device and the destination device must have dedicated STB and can share a single STB and the same is illustrated in the following embodiments.

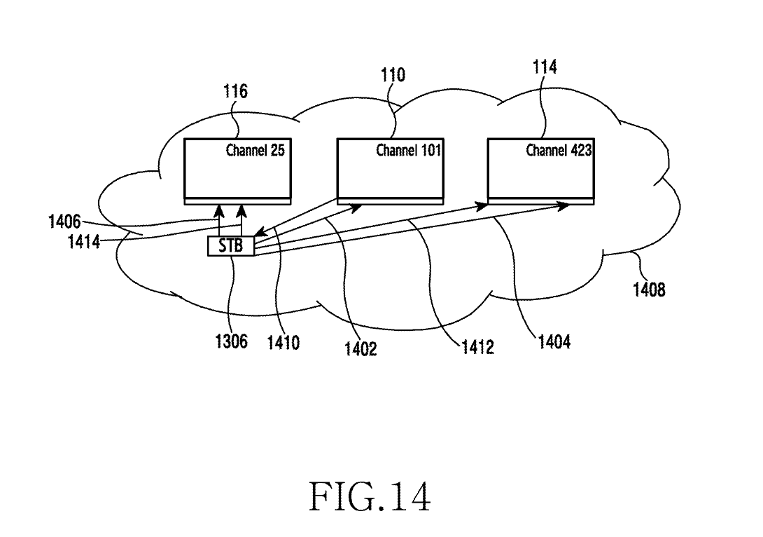

FIG. 14 illustrates a recommendation message delivery in a network constituted by a recommending device connected to a single set top box (STB) and a plurality of destination devices according to an embodiment of the present disclosure.

Referring to FIG.14, the recommending device 110 and each of the destination device 114, 116 can be connected to a single STB 1306 and each of the three devices 110, 114 and 116 are streaming data pertaining to different channels from the shared STB 1306. This is illustrated by reference numerals 1402, 1404 and 1406. It may be noted that it is possible for the aforesaid to occur if the STB has a number of physical tuners (hardware support) for multiple channel data streaming to multiple devices at the same time. Also, the aforesaid is feasible if the STB and each of the three devices 110, 114 and 116 form part of a home network 1408. In case the STB and the three devices form part of the home network 1408, using any of DLNA or RVU or RUI or UPnP or DLNA CVP2 protocol, and a HTTP streamer server (not specifically illustrated), each of the three devices can stream broadcast channel contents. In this case, the recommending device 110 will receive a signal indicative of a recommendation from a user (not specifically illustrated). In response to the above, the recommending device 110 will forward 1410 either a content recommendation message or the signal itself to the STB 1306. The STB 1306 will then deliver the content recommendation message to the one or both of the destination devices (as per the destination device information contained in the signal indicative of the content recommendation). In case the content recommendation message is to be delivered to the two destination devices 114 and 116, the STB 1306 delivers 1412 and 1414 the content recommendation message to the two destination devices 114 and 116.

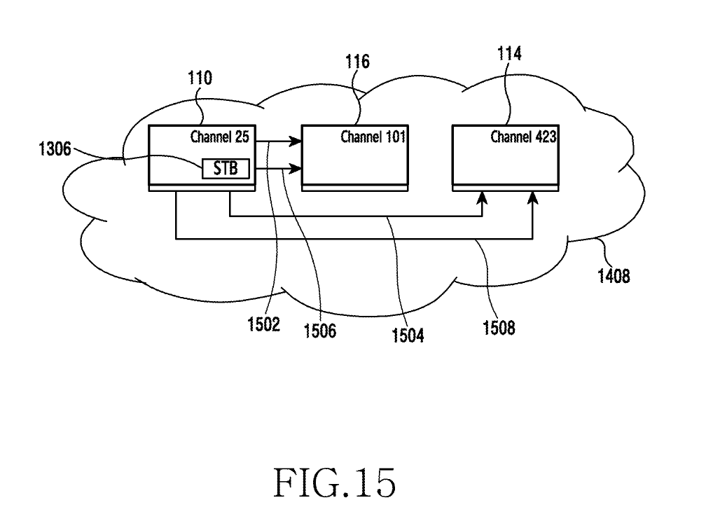

FIG. 15 illustrates a recommendation message delivery in a network constituted by a recommending device comprising an integrated STB and a plurality of destination devices according to an embodiment of the present disclosure.

Referring FIG. 15, the recommending device 110 can be integrated with a single STB 1306 and each of the destination devices 114, 116 can be connected to recommending device 110 and are adapted to streaming data 1502, 1504 pertaining to different channels from the single integrated shared STB 1306. It may be noted that it is possible for the aforesaid to occur if the STB has a number of physical tuners (hardware support) for multiple channel data streaming to multiple devices at the same time. Also, the aforesaid is feasible if the recommending device 110 and each of the remaining devices 114 and 116 form part of a home network 1408. In case the recommending device having the integrated STB and the destination devices form part of the home network 1408, using any of DLNA or RVU or RUI or UPnP or DLNA CVP2 protocol, and a HTTP streamer server (not specifically illustrated), each of the remaining two devices (which do not have a dedicated STB) can stream broadcast channel contents from the device which has the integrated STB. In this case, the recommending device 110 will receive a signal indicative of a recommendation from a user (not specifically illustrated). In response to the above, the recommending device 110 will provide either a content recommendation message or the signal itself to the STB 1306. The STB 1306 will then deliver the content recommendation message to the one or both of the destination devices (as per the destination device information contained in the signal indicative of the content recommendation). In case the content recommendation message is to be delivered to the two destination devices 114 and 116, the STB 1306 delivers 1506 and 1508 the content recommendation message to the two destination devices 114 and 116. In this case, all the devices (whether they have the integrated STB or NOT) can still generate and send content recommendation message to other devices. In such a scenario, the device which receives the signal indicative of the content recommendation establishes a connection with the STB and then via the STB sends the content recommendation message to the appropriate destination devices.

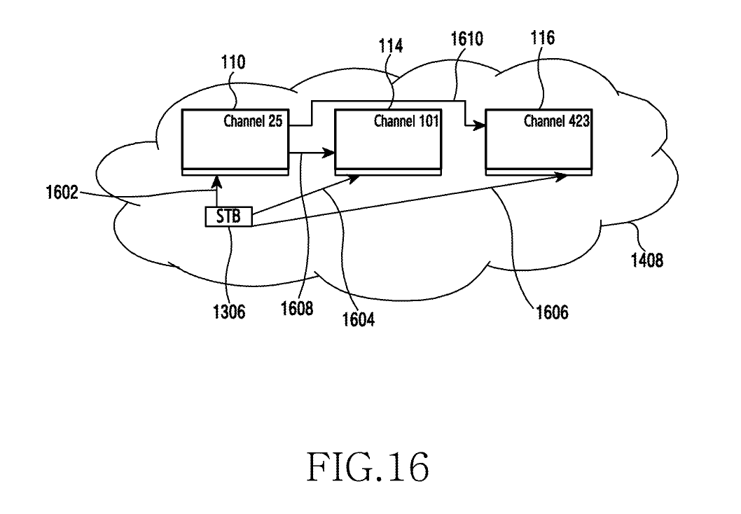

FIG. 16 illustrates an alternative mechanism for recommendation message delivery in a network constituted by a recommending device connected to a single STB and a plurality of destination devices according to an embodiment of the present disclosure.

Referring to FIG. 16, the recommending device 110 and each of the destination device 114, 116 can be connected to a single STB 1306 and each of the three devices 110, 114 and 116 are streaming data 1602, 1604 and 1606 pertaining to different channels from the shared STB 1306. It may be noted that it is possible for the aforesaid to occur if the STB has a number of physical tuners (hardware support) for multiple channel data streaming to multiple devices at the same time. Also, the aforesaid is feasible if the STB and each of the three devices 110, 114 and 116 form part of a home network 1408. In case the STB and the three devices form part of the home network 1408, using any of DLNA or RVU or RUI or UPnP or DLNA CVP2 protocol, and a HyperText Transfer Protocol (HTTP) streamer server (not specifically illustrated), each of the three devices can stream broadcast channel contents. In this case, the recommending device 110 will receive a signal indicative of a recommendation from a user (not specifically illustrated). In response to the above, the recommending device 110 will formulate the content recommendation message and deliver the same to one or both of the destination devices (as per the destination device information contained in the signal indicative of the content recommendation and based on the status of the destination device). In case the content recommendation message is to be delivered to the two destination devices 114 and 116, the recommending device 110 delivers 1608 and 1610 the content recommendation message to the two destination devices 114 and 116. Thus, it can be noticed that in this case, the STB does not participate in delivering the content recommendation message to the destination devices. Because of the above, every device in the network 110, 114, and 116 can be considered to be placed at an equal status with respect to the remaining devices.

In an alternative approach, which is not specifically illustrated, the recommending device and each of the destination devices can be interconnected to form a network. An STB device can be provided either as an external component connectable to the remaining devices (as illustrated in FIGS. 14 and 16) or as an internal component of a particular device (as illustrated in FIG. 15). Differing from the previously illustrated examples, the STB can have an internal hard disk, where any of the users connected to the STB can store their content. Alternatively, the STB with the internal hard disk can function as a personal recorder to record any of the received broadcast content under the instruction of any of the users who have access to the STB. Now adopting any of the procedures as described with reference to FIG. 14, 15 or 16, a content recommendation message corresponding to a content thus stored in the internal hard drive of the STB can be prepared and sent to any of the destination devices. It would be appreciated that under the above circumstance, if presence of the content on the internal hard disk of the STB is visible to a particular device, a user of the device can then formulate a content recommendation message for delivery to other destination devices. While this enables for sharing of content, if the content is protected by certain DRM parameters, the destination device can still seek the appropriate permissions from the content owner.

It will be further appreciated that the same scenario can be applied to recorded content stored on shared storage device (internal/external hard drive or pen drive). The shared storage device is accessible to both the recommending device and the destination device. In this case, the recommending device enables USER A who has recently recorded one broadcast show using a recorder integrated with the recommending device to send a content recommendation message to USER B. The present disclosure enables the recommending device to receive a recommendation message even in the form of a single press of a button from a remote control device which may be available with USER A or based on a voice command or based on a gesture command, and on the basis of the same, send a recommendation message as “Recommendation from USER A: Recorded content Name: Dexter season 2 Episode 11, Duration: 45 Minute, Location: Internal Hard drive 1” to a destination device which is being accessed by USER B. The present disclosure furthermore enables the destination device to receive an acceptance to view the recommended content even in the form of a single press of a button from a remote control device which may be available with USER B and on the basis of the same, start streaming the recorded content from the appropriate source (as identified in the content recommendation message) and output the recommended content. In this case, it is pertinent to note that the recording while being available on the shared storage device, need not have been initiated by USER B. Similarly, it is also feasible that the content as available on the shared storage device may be a content recorded by a third party (i.e. a part other than USER A and USER B) and even then, USER A can send the content recommendation message to USER B. This scenario takes care of the fact that USER B may not have knowledge of the fact that content may be already available on the shared storage device.

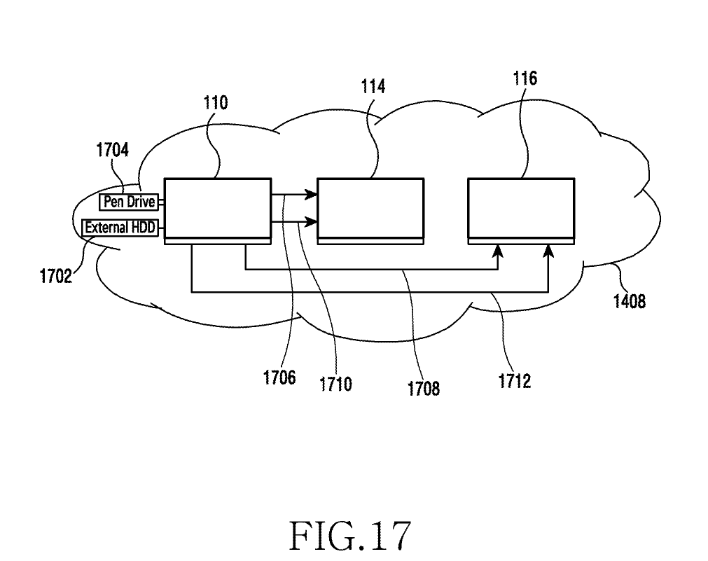

FIG. 17 illustrates a recommendation message delivery specifically pertaining to stored content in a network constituted by a recommending device connected to one or more storage devices and a plurality of destination devices according to an embodiment of the present disclosure.

Referring to FIG. 17, it will be appreciated that if there are lots of computer generated Music/Videos/Images/documents stored on a storage device like pen drive/hard disk/internal hard disk, then searching a particular content is very difficult. Thus, as illustrated in FIG. 17, the present disclosure enables a recommending device 110 which is browsing or watching a Movie/Music/Image/document, stored on one or more storage devices 1702, and 1704, to recommend to one or more destination devices 114, 116 a particular content. The recommending device 110 can receive a signal indicative of such recommendation from a user via a user interface device. At the same time, the present disclosure enables the content recommendation message to be delivered 1706, and 1708 to the destination device 114 or 116. For example, the recommendation message can state “USER A has just recommended a Movie/Music/Image from a portable device (such as pen drive 1/hard disk 1/compact disc (CD) player/Blu-ray-hard disc drive (BD-HDD) player etc.). Name of the content: LIFE of PIE, Total Duration: 2:33 Hr.” Now it's up to user at the destination device 114 or 116, who can ignore or else can accept the content recommendation message by providing an acceptance signal. The acceptance or ignorance of signal can be provided to the destination device by using a user interface device, for example, a remote control device. Upon receiving the acceptance signal from the user, the destination device 114 or 116 will start streaming 1710 or 1712 the recommended content from the appropriate source (as identified in the content recommendation message) and will initiate output of the content to the user. It may be noted that prior to sending the content recommendation message by the recommending device 110 to the appropriate destination device 114 or 116, the status of the destination device is determined and the content recommendation message is delivered only if the destination device is in ON status. Since all the three devices 110, 114 and 116 are connected to each other, the status information can be collated with any of the devices (for example with device 110. It will be appreciated that in case a device which does not have the interconnected pen drive/hard disk/internal hard disk wishes to recommend a content to any of the devices (including the device to which the pen drive/hard disk/internal hard disk is directly connected), the same is also feasible. Assuming that device 114 wishes to send a recommendation to the other two devices 110 and 116, device 114 will seek from device 110 the status information pertaining to all other connected devices. The content recommendation message directed to device 110 will be directly delivered while a content recommendation message directed to device 116 could be either delivered directly or indirectly (i.e. via device 110. In case device 116 accepts the content recommendation message, the content will be fetched from device 110 (with the device 110 behaving like a server).

To provide a further holistic picture of the entire scenario, one can consider the process of rendering the content recommendation message and the content at the destination device to be constituted of the following operations:
request initiation;
device discovery;
destination device selection;
retrieval of content related data;
preparation of content recommendation message;
sending of content recommendation message to the destination device; and
rendering of the content recommendation message and content at the destination device.

In the following paragraphs, a brief note about each operation is provided for the purposes of ease of understanding.

Request Initiation: When a user of an audio visual device wants to send recommendation to other users whose audio visual devices are connected to the network, in the very first operation the user will send a request for sending specific content recommendation through his/her audio visual device, for example, by pressing a button or by providing a voice command or by providing a gesture based command. During request initiation for content recommendation, user of the recommending device can have option to send recommendation for current ongoing content on the recommending device or any other content from channel list, EPG list or copied/recorded content list.

Device Discovery: As the content can be recommended to specific destination devices which are forming part of the network, it is preferable to undertake a device discovery procedure to retrieve the current information of the interconnected devices. During the device discovery, information of all interconnected devices along with their current status are retrieved. This information can be in the form of a list (which may not include the recommending device).

Destination Device Selection: The list of all interconnected device will be displayed at recommending device and user using any user interface means can choose/select one or multiple destination devices to send content recommendation message. The user interface means can be any of a remote control or voice based command or gesture based command.

Retrieve Content Related Data: After getting the selected destination device information and for the purposes of preparing the content recommendation message, there can be operation of collecting or collating all of the pertinent information. By way of example, additional data pertaining to the content selected including metadata corresponding to the selected content can be collected. By way of yet another example, it is possible to retrieve EPG data provided by broadcaster or can use any image detection technology to find the channel logo. By way of another example, if the user at the recommending device has opted to provide any customized message, the same can also be collected. In some other examples, thumbnail for that recommended content (channel or computer generated or recorded content) can be obtained, which could be used by destination user as a preview or image presentation of that recommended content. It can be noted that this operation can be performed interchangeably with respect to the operation of destination device selection.

Prepare Recommendation: The content recommendation message using all of the information thus collected or collated. By way of a non-limiting example, the content recommendation message can be in the form of “USER A has recommended a Movie/Music/Image from a portable device (such as pen drive 1/hard disk 1/CD player/Blu-ray-BD-HDD player etc.).Name of the content: LIFE of PIE, Total Duration: 2:33 Hr”. In yet another non-limiting example, the content recommendation message can be “Recommendation from USER A: Recorded content Name: Dexter season 2 Episode 11, Duration: 45 Minute, Location: Internal Hard drive 1”. By way of yet another non-limiting example, the content recommendation message can be “Recommendation from USER A: Channel No: 501, Channel: AXN, Program: Oscar Award Show, Duration: 8:30 PM To 10:30 PM”.

Send Recommendation: Now the status of the destination device will be checked i.e. whether destination device is switched OFF or ON. If the destination device is switched ON then immediately the content recommendation message will be sent to the destination device. On the other hand, if the destination device is switched OFF, the content recommendation message will be stored for future delivery to the destination device. Particularly, if a particular destination device is in switched OFF mode, the content recommendation message can be stored in a database. While storing the content recommendation message in the database it would be advantageous to store the recommendation message in an easily differentiable manner. By way of a non-limiting example, messages recommending broadcast channel, can be stored so as to be easily differentiable from messages recommending stored content. Without wanting to be limited to the specific implementation, this can be attained by segmenting the database into multiple modules and storing the messages in the appropriate segment of the database.

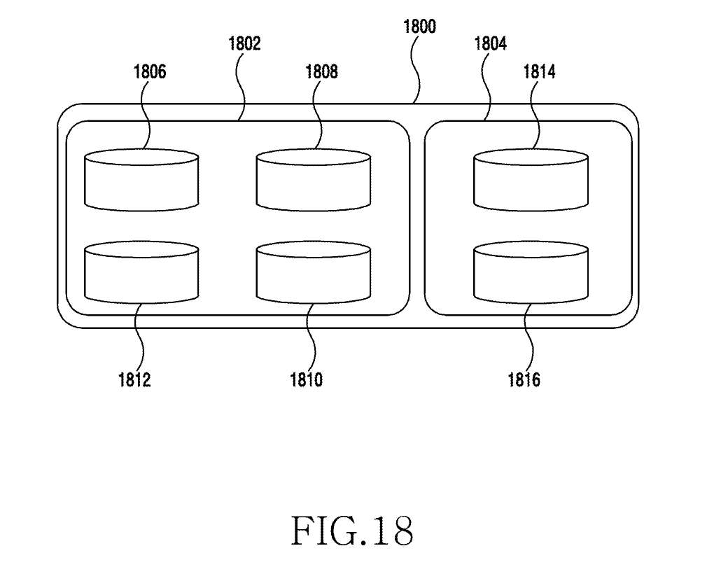

FIG. 18 illustrates an internal configuration of a dataset adapted to store content recommendation messages according to an embodiment of the present disclosure.

Referring to FIG. 18, a database 1800 can consists of two segments, namely EPG database at 1802 for channel broadcast data and stored content database 1804 for stored content on storage devices. If recommendation message pertains to a channel data then the same can be stored into EPG database and if the recommendation message pertains to a stored content then the same can be stored into stored content database. Once again by way of non-limiting example, The EPG database 1802 can additionally consist of Program metadata table 1806, channel metadata table 1808, channel information table 1810 and destination device list and information 1812. Program metadata table 1806 can hold data related to program, which currently user is viewing at the recommending device and channel metadata table 1808 can hold data related to channel, which currently user is viewing at the recommending device. As an example suppose Tom is watching a News show on his television at channel number 501, which is WORLD NEWS channel. So in that case Program metadata table 1806 will hold news show related data and channel metadata table 1808 will hold data related to channel like channel number, channel name and so on. Channel information table 1810 can hold other metadata like user recommendation message along with recommending device or source user information. Destination device list and information 1812 can hold all the destination device information to which the recommending device wants to send channel recommendation. Once again by way of non-limiting example, the stored content database 1804 can consist of stored content metadata table 1814 and destination device information table 1816. Stored content metadata table 1814, can hold information for the stored computer generated copied content and recorded content on storage device (internal/external) and destination device information table 1816 can hold all the destination device information to which recommending device wants to send stored content recommendation.

If channel recommendation to a currently switched off television is being sent, then the content recommendation message will be stored and more particularly, the program data, channel data, destination client information along with user message be stored in the database. The channel recommendation message can be delivered to the destination device and acceptance to view the recommended channel program can be received from the destination device, at least till the recommended content is being broadcasted. In case of channel recommendation, program start time and end time will be stored into database. So if a particular destination device comes to switched ON state, after end time of the program, then only the recommendation message can be sent to destination device. Especially in case of such scenario, the feasibility of the destination device accepting the content recommendation message can be further controlled. By way of a non-limiting example, the control can be exhibited such that the destination device may not be able to accept that recommendation request from the recommending device, as that particular show already finished broadcasting.

In an embodiment of the present disclosure, the control can be exhibited such that instead of sending the original content recommendation message with the original telecast related timing, the timings of a repeat telecast can be communicated to the destination device. In this scenario also, acceptance of the content recommendation can be controlled such that the acceptance can be considered as a temporary acceptance of a future broadcast.

In an embodiment of the present disclosure, the control can be exhibited such if any of the destination devices is switched OFF, the content can be recorded and stored. Once any of the currently switched OFF destination devices is switched ON, the recommendation message can be delivered thereupon. Since the content has been recorded and stored, in this scenario, once an acceptance is received from the destination device, the content can be sent to the destination device (from the storage device).

By storing the recommendation message in an easily differentiable manner, the above operations can be more effectively performed.

However in case of normal copied and recorded content this scenario would be different. In such scenario, if the destination device is switched ON, the pending recommendation along with content metadata can be sent to the destination device and responses from the destination device can be controlled for example, to fall under the category of acceptance or denial. It is also feasible to provide for other options such as deferred streaming of content, which can be said to be equivalent to storing content recommendation for a further period of time.

Display of Recommendation Message and content: Once the destination device gets the recommendation message, the same will be rendered. The rendering can be as per one or more manners including display of the content recommendation message as a popup or audio representation of the same. Destination device can also have option to render a preview of that recommended content using PIP mode.

For channel content recommendation from a recommending device, the destination device can allow the user to enter any of the two options: ACCEPT or DENY for that recommended content. If the user at the destination device wants to watch that channel program, streaming of the broadcast channel can be triggered upon receiving an ACCEPT signal from the user. The ACCEPT signal can be received from any of the user interface devices such as remote controller or via voice command or via gesture command. On the other hand, if DENY signal is received, the streaming of the broadcast channel would not be triggered.

For normal copied content or recorded content recommendation from recommending device, the destination device can have provide three options for selection to the user. ACCEPT or REMEMBER RECOMMENDATION or DENY.

The destination device, in response to receiving an ACCEPT signal, commence streaming and rendering of the content from storage device. The ACCEPT signal can be received from a user interface device such as a remote control device or via voice command or via gesture command.

The destination device, in response to receiving a DENY signal, can discard the recommendation message and take no further action in respect of the same.

The destination device, in response to receiving a REMEMBER RECOMMENDATION signal, store the recommendation message for future action. In this option, the destination device, will initially ACCEPT the recommendation request and to add these content recommendation information to “Remember Recommendation Content” list to watch it a later time by streaming it from the storage device. This option may be beneficial for example in a scenario wherein a user at the destination device is watching one important news program and at the same time he receives recommendation message for copied content recommendation from a recommending device. In this scenario, the destination device enables the user to continue to watch the content and automatically stores the recommendation message for his future reference. During any future point in time, the user can scan through the recommendation messages thus stored and opt for watching the recommended content or deleting the recommendation message.

In order to implement the overall process of rendering the content recommendation message and the content at the destination device the present disclosure provides for a system comprising of the following modules:
a request initiation module;
a device discovery module;
a destination device selection module;
a module for retrieving content related data;
a module for preparing content recommendation message;
a content recommendation message sending module;
a module for displaying recommendation message and content information.

Referring back to FIG. 1, it will be appreciated that the network 100 can be constituted by multiple devices and there is no control on the individual configuration of these devices. For example, there can be audio visual devices, audio visual devices integrated with STB, standalone STBs, digital media servers not having the capability of receiving broadcast, digital media servers having the capability of receiving broadcast, audio visual devices with integrated recorder, STBs with integrated recorders, servers with integrated recorder without having the capability of receiving broadcast, servers having the capability of receiving broadcast, audio players, etc. forming part of the network in which the content is intended to be recommended and shared. Keeping in view the fact that networks can be thus formed of devices of different capabilities, it is in the interest of the present disclosure to enable realization of the above modules in multiple ways.

By way of a non-limiting example, content recommendation can be made by any recommending device (Audio visual device) in the home network, where recommending device television is different from server (which has direct access of the recommended content). Here server can be in the form of a STB or a television integrated STB, which will be capable of receiving broadcast channel data, recording broadcast video data and has internal or external storage or copied/recorded content. Recommending device can be a simple audio visual device, which has network access to server. So In this scenario, it is feasible to realize the request initiation module and the destination device selection module; as part of the recommending device and realize the module for displaying recommendation message and content information as part of the destination device and the remaining modules as part of the server.

By way of another non-limiting example, content recommendation can also be made by server (which has direct access of the recommended content).Here server (television integrated STB) will be capable of receiving broadcast channel data, recording broadcast video data and has internal or external storage or copied/recorded content. So recommending device can be thought of as television with integrated STB. So in this scenario, it is feasible to realize the module for displaying recommendation message and content information as part of the destination device and all other modules as part of the server or the recommending device.

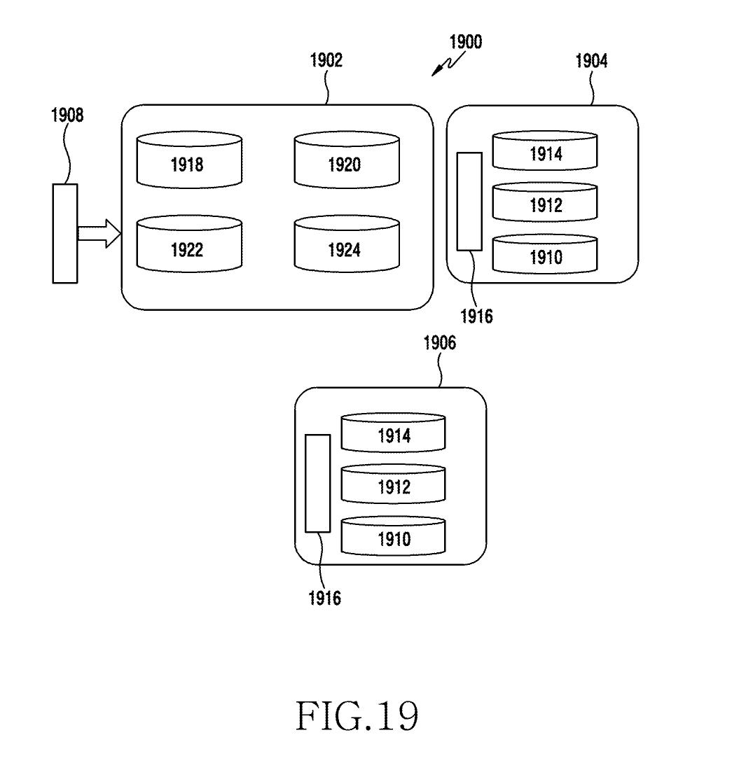

FIG. 19 illustrates a server-client configuration for delivery of content recommendation messages according to an embodiment of the present disclosure

It may be noted that the presence of a dedicated server in the network is not essential. However, in case there is a dedicated server (such as a digital media server), it is possible to implement a server - client configuration. Referring to FIG. 19, a server-client configuration 1900 includes a dedicated server device 1902 that can be configured to interact with multiple client devices 1904, 1906. Apart from the above, external hard drives 1908 can be connected to the dedicated server. In a server/client configuration, the server 1902 can be delineated with performing more tasks and the client devices 1904, 1906 can be built to perform limited task. By way of example, in such a configuration the client devices can be realized with module for displaying recommendation message and content 1910, destination device selection module 1912 and a module for request initiation 1914. Apart from the above, a module for maintaining connection 1916 with the server can be provided as part of the client device. All other modules such as device discovery module 1918; module for retrieving content related data 1920; module for preparing content recommendation message 1922; content recommendation message sending module 1924, etc. can be realized as part of the server device.

To provide some illustrations regarding implementation in a network comprising a server, attention is drawn to the following paragraphs. It would be appreciated that in a home network setup using a Wi-Fi/local area network (LAN) setup, one can be one server capable of receiving broadcast signal, capable of recording broadcast contents using integrated recorder and can have internal hard drive attached with it or can have hardware setup to attach external storage device (hard drive or pen drive etc.) into server. So one can consider a server as a STB or a television integrated STB. In such a configuration, the server can have multiple physical tuners to support multiple streaming of broadcast channel contents to multiple streaming clients at the same time. There will be one streaming server running on server to support multiple streaming of contents to multiple clients in the home network. There could be more than one client for that server, which is able to stream out broadcast channel data and copied and recorded content data at a client television. The number of streaming channel broadcast content at the same time to clients will be depend on number of physical tuners attached with that server. For STB as a server one can have another television which will be attached with that STB with high definition multimedia interface (HDMI) and can be treated as a server display.

With this specific setup, a user in the home network may send to any other user.

A user watching any content in one of the client television can send recommendation for the same content to other users using clients television and as well as the user using server television.

A user watching any content using server television can also send recommendation for the same content to other users using client's television.

Now, while sending a recommendation, a first source client will have a list of all other connected clients information in that network. Then, the user using the source client television can choose multiple or one client to send the current ongoing content recommendation.

Now, a server will process the request and send that recommendation to a destination client television and a user using destination client television can have option to ACCEPT or DENY the recommendation request. User once ACCEPTS the recommendation request destination client television will start streaming of that particular recommended. But if user DENIES the recommendation request, the destination client television will continue with previous content display, which was viewed by the user on destination client television.

Now, a source client after getting all connected client information in the network along with ongoing content information can display the same list of connected client televisions information on source television and user can choose one or multiple client from that list and send that recommendation along with ongoing content information. A user using destination client television can have option to ACCEPT or DENY the recommendation request. A user once ACCEPTS the recommendation request destination client television will start streaming of that particular recommended. But if the user DENIES the recommendation request, the destination client television will continue with previous content display, which was viewed by the user on destination client television.

With this specific setup, multiple modes can operations can be implemented and some of the non-limiting methods of operations are described below.

Case 1: If Source Client television is different from server (which has direct access of the recommended content)

Here server (STB/television integrated STB) will be capable of receiving broadcast channel data, recording broadcast video data and has internal or external storage or copied/recorded content. Source client television is a simple audio visual device, which has network access to server.

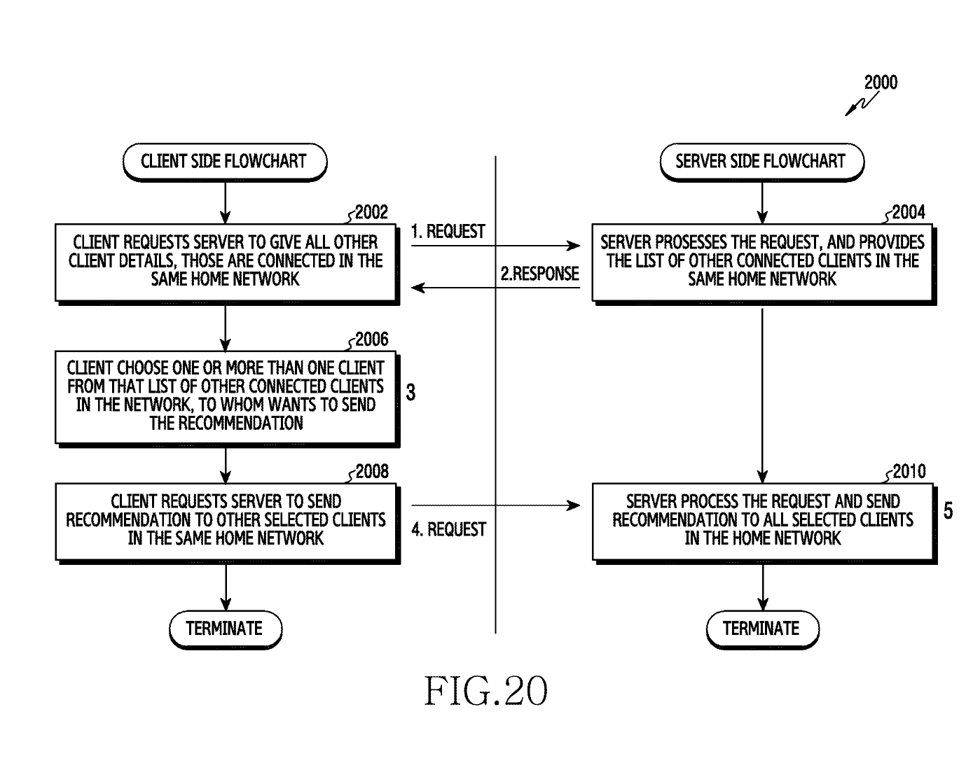

FIG. 20 illustrates a flowchart depicting interactions between a. client and a server while sending a recommendation according to an embodiment of the present disclosure, when a recommending device is different from a server.

Referring to FIG. 20, there is provided a flowchart 2000 for content recommendation according to the present disclosure, The flowchart depicts interactions between the client and server while sending recommendation according to present disclosure, when recommending device is different from server. When user wants to send recommendation to any of the other user in the same home network, the following operations would be performed:

Operation 1: Recommending device will request to server for all the connected client information in the same home network. That request for other clients in the network will go to the server at operation 2002.

Operation 2: Server will retrieve all other connected client information from the stored network client list and send the response to client (recommending device operation 2004.

Operation 3: Recommending device client display all the connected client list in the network and receive from the user selection relating to one or more than one destination devices client, to which content recommendation message is to be sent at operation 2006.

Operation 4: Recommending device will send request to server for sending currently viewing content's recommendation to alf the selected destination devices at operation 2008.

Operation 5: Server processes the request and sends the content recommendation message to each destination device one by one at operation 2010.

Case 2: If Source Client television is same as server (which has direct access of the recommended content)

Here server (television integrated STB) will be capable of receiving broadcast channel data, recording broadcast video data and has internal or external storage or copied/recorded content. So Source client television can be thought of as television with integrated STB.

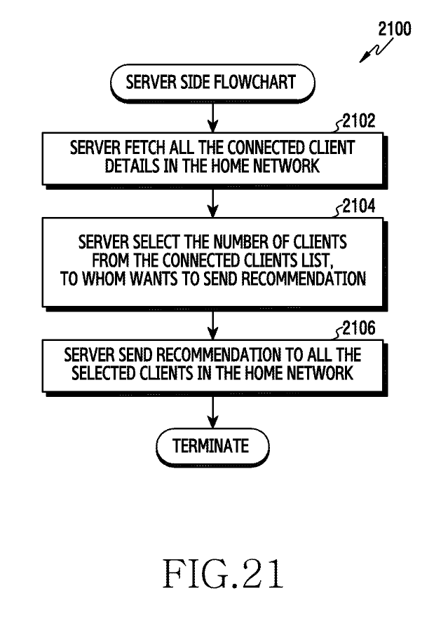

FIG. 21 illustrates a flowchart depicting a. process as performed by a recommending device (which also functions as a server) according to an embodiment of the present disclosure.

Referring to FIG. 21, there is provided a flowchart 2100 for content recommendation according to the present disclosure. The flowchart depicts the process as performed by a recommending device (which also functions as the server). When the user wants to send recommendation to any of the other users in the same home network, the following operations would be performed:

Operation 1: when a. user, setting at server side, wants to send recommendation to other client in the home network, server will fetch the connected client list and display the same to the user at operation 2102.

Operation 2: Out of those connected clients, the user will choose one or more than one client, to which the user wants to send a content recommendation. And the server processes the user request at operation 2104.

Operation 3: The server then sends the content recommendation to all of the selected clients in the network at operation 2106.

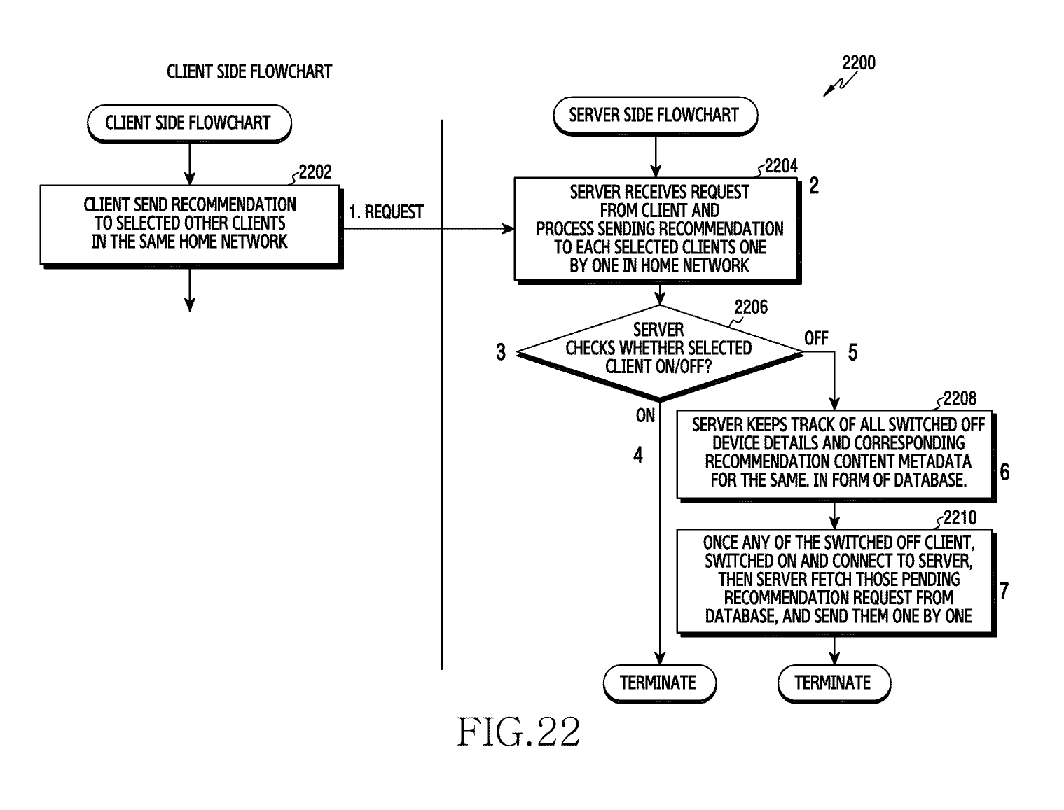

FIG. 22 illustrates a flowchart depicting interactions between a client and a server while sending a recommendation according to an embodiment of the present disclosure, wherein the recommending device sends the recommendation message without analysing the status of the connected devices according to an embodiment of the present disclosure.

Referring to FIG. 22, a recommending device without analysing the status of the connected devices sends the recommendation message to the server and the server delivers the recommendation based on the status of each destination device. This embodiment is illustrated in FIG. 22 it can he seen that in this embodiment, the method comprises:

Operation 1: A recommending device sending a content recommendation directly to the server without requesting for status of the connected client information in the same home network at operation 2202.

Operation 2: The server will receive the recommendation messages and process the same for sending to the selected destination devices at operation 2204.

Operation 3: The server checks for status of the destination device and if the destination device is in ON status, the recommendation message is delivered and the operation is terminated at operation 2206.

Operation 4: In case a particular destination device is in OFF status, the server keeps track of all such switched ON destination devices and stores the recommendation message in a database at operation 2208.

Operation 5: Once the server detects that a particular destination device is turned ON, the server fetches the pending recommendation message from the database and send the same to the destination device at operation 2210.

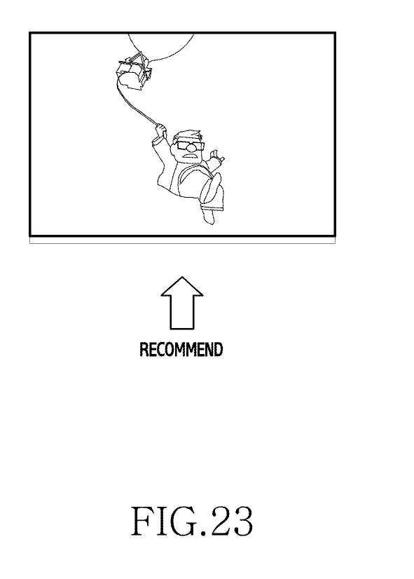

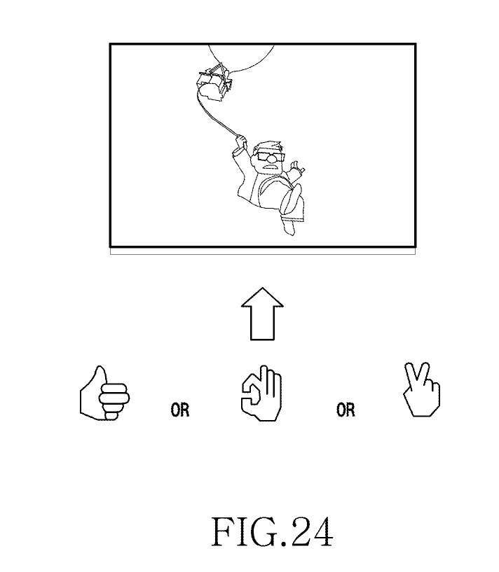

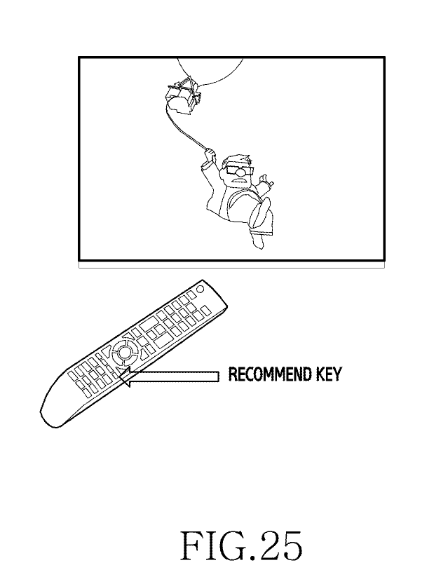

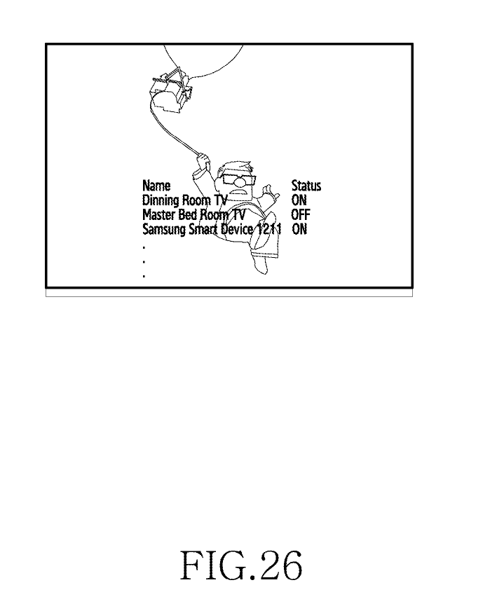

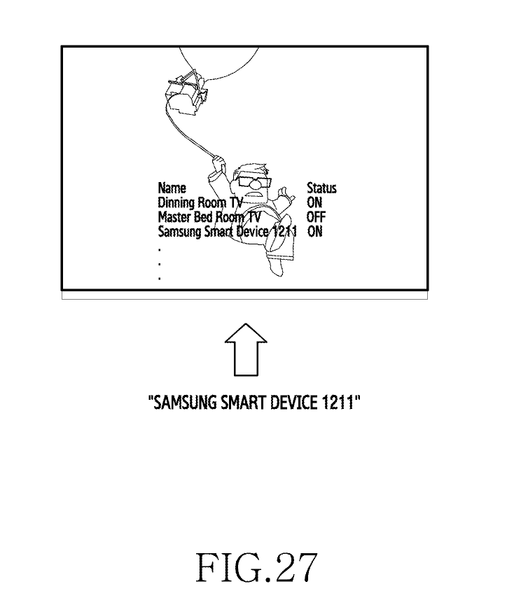

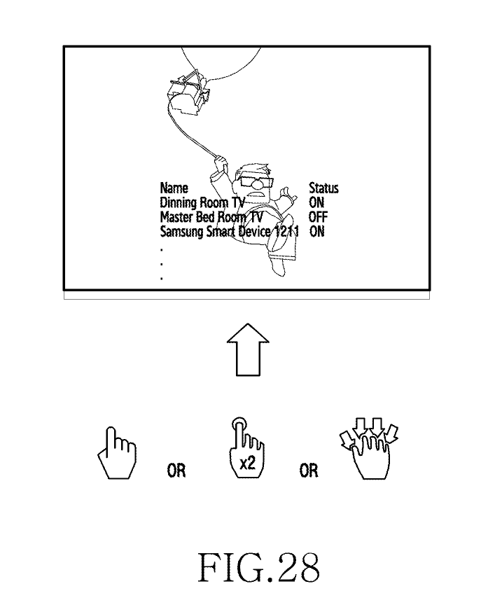

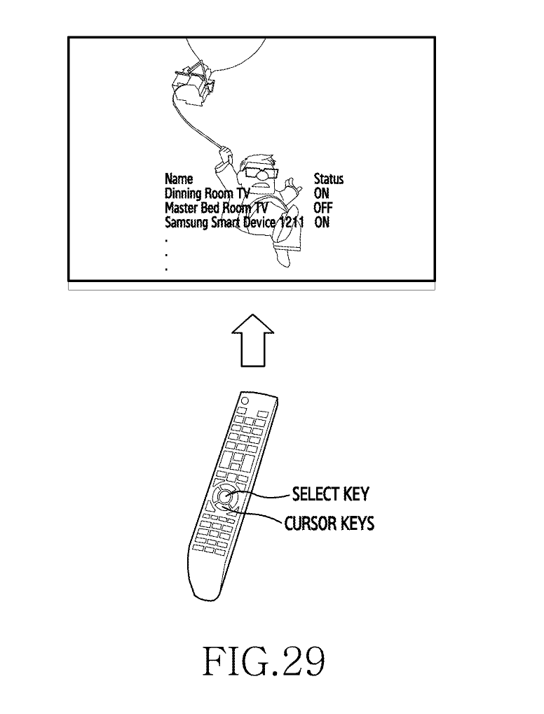

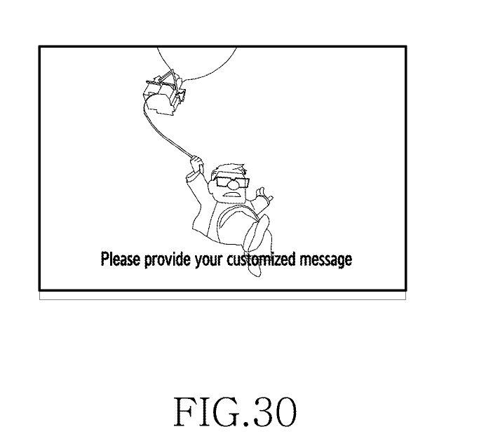

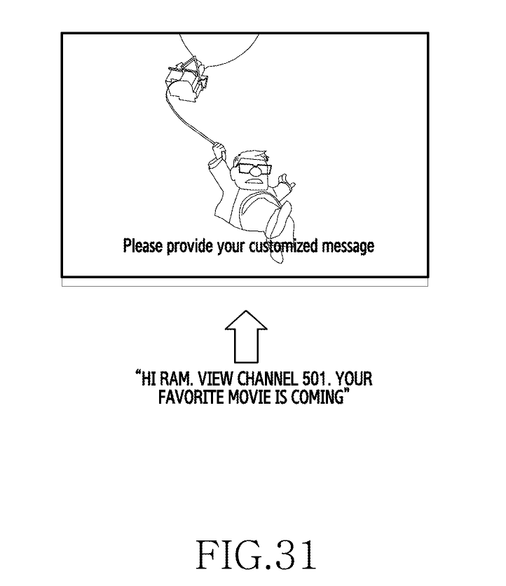

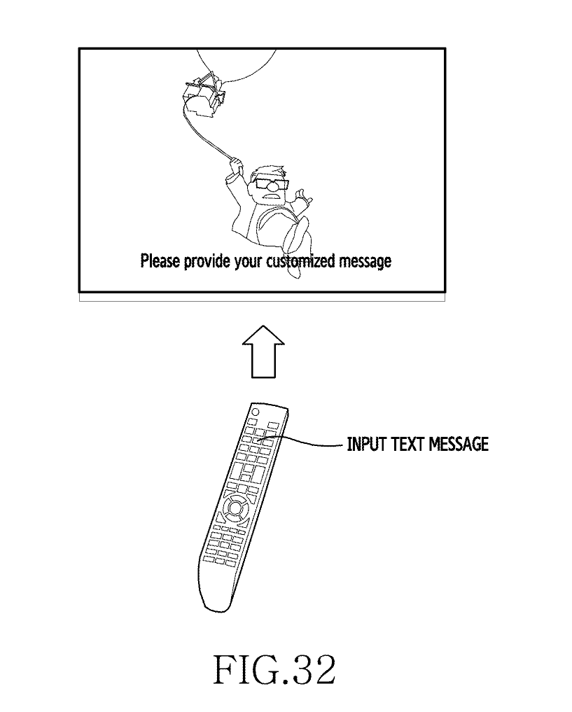

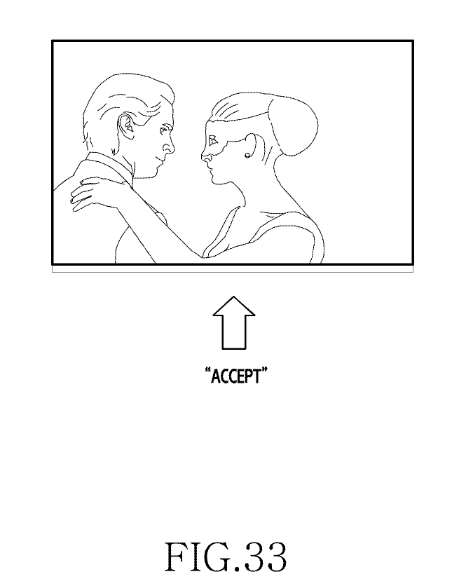

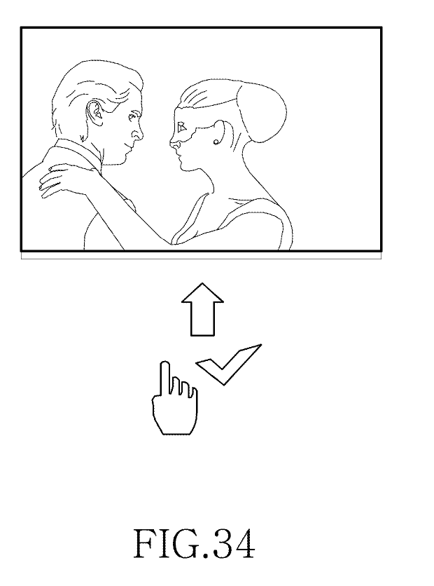

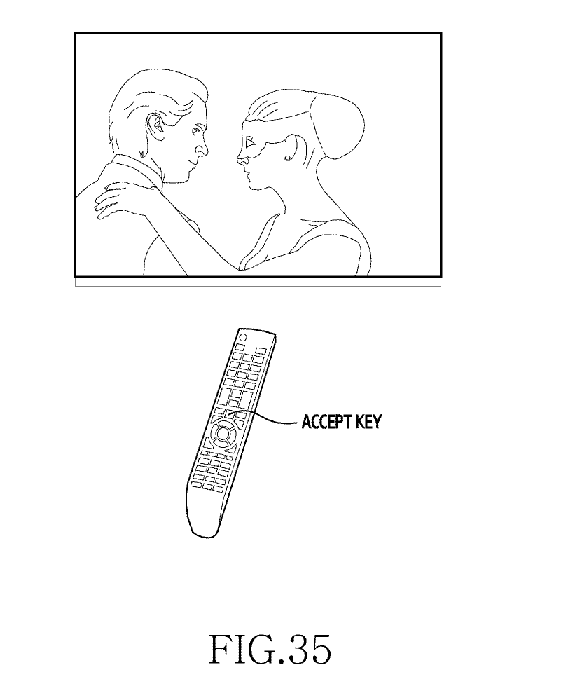

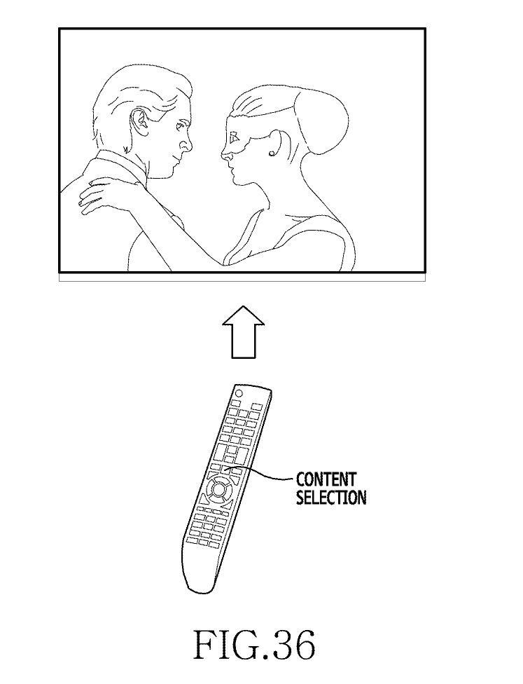

FIG. 23 illustrates receiving a recommendation command via a voice command while a user is viewing a broadcast channel according to an embodiment of the present disclosure. FIG. 24 illustrates receiving a recommendation command via a gesture based command while a user is viewing a broadcast channel according to an embodiment of the present disclosure. FIG. 25 illustrates receiving a recommendation command via a graphical user interface such as a remote control while a user is viewing a broadcast channel according to an embodiment of the present disclosure. FIG. 26 illustrates an example for depicting a status of a connected device at the recommending device according to an embodiment of the present disclosure. FIG. 27 illustrates receiving a voice based command selecting a destination device according to an embodiment of the present disclosure. FIG. 28 illustrates receiving a gesture based command selecting a destination device according to an embodiment of the present disclosure. FIG. 29 illustrates receiving a graphical user interface command selecting a destination device according to an embodiment of the present disclosure. FIG. 30 illustrates a recommending device enabling a user to input a customized message according to an embodiment of the present disclosure. FIG. 31 illustrates receiving an audio message to be included in a content recommendation message according to an embodiment of the present disclosure. FIG. 32 illustrates receiving a text message to be included in a content recommendation message according to an embodiment of the present disclosure. FIG. 33 illustrates receiving a voice based acceptance command at a destination device according to an embodiment of the present disclosure. FIG. 34 illustrates receiving a gesture based acceptance command at a destination device according to an embodiment of the present disclosure. FIG. 35 illustrates receiving an acceptance command via a graphical user interface such as a remote control at a destination device according to an embodiment of the present disclosure. FIG. 36 illustrates an interface made available by a recommending device to a user for enabling selection of stored content according to an embodiment of the present disclosure.

Referring to FIGS. 23 - 36, some of the modes of operation of the recommending device are illustrated. Assuming that the user is interested in sending a recommendation message pertaining to a channel content being viewed by him on the recommending device, the user provides a command to the recommending device. Depending upon the configuration of the recommending device, the user can provide a voice based command or a gesture based command or a graphical user interface based command. By way of example, as illustrated in FIG. 23, the user provides a voice command “recommend” while viewing a broadcast channel. Any other voice based command as may be configured can be provided by the user. By way of another example, as illustrated in FIG. 24, the user provides gesture based command, which by way of example, include a “thumbs-up gesture”, a “OK-Gesture” or a “Victory-gesture” or any other gesture. By way of yet another example, as illustrated in FIG. 25, the user can provide the command via a graphical user interface such as a remote control. In this case, any key on the remote control can be configured such that upon actuation of the key, the command for “recommendation’ can be detected.

The recommending device can display on a screen all the connected devices. The recommending device can fetch the information of the connected devices in any of the manner as already described. FIG. 26 illustrates an example for depicting the status of the connected devices. It may however, be noticed that other manner of depicting the status of the connected devices is also feasible.

The recommending device can receive from the user selection relating to one or more than one destination devices. The user selection pertaining to a particular connected device i.e. selecting a particular device as a destination device can be once again received through a voice based command or a gesture based command or a graphical user interface based command. By way of example, as illustrated in FIG. 27, the user provides a voice command identifying the destination device. By way of another example, as illustrated in FIG. 28, the user provides gesture based command, which by way of example, include a “single-tap gesture”, a “double tap gesture”, a “grab gesture” or any other gesture. By way of yet another example, as illustrated in FIG. 29, the user can select a particular destination device via “cursor” and “select” keys of a remote control.

In addition to the above, as illustrated in FIG. 30, the recommending device can enable the user to input a customized message. The customized message can be in the form of a text message, an audio message, a video message, an image, of a combination thereof FIG. 31 illustrates receiving an audio message to be included in the content recommendation message, while FIG. 32 illustrates receiving a text message to be included in the content recommendation message.

Aspects such as creation of the content recommendation message, sending of the content recommendation message, etc. can be performed in any manner as described above.

Now referring the content recommendation message (which includes a customized text) is displayed at the destination device. In response to displaying the content recommendation message, the destination device may prompt the user to provide an “acceptance” command or may detect an “acceptance” command. By way of example, as illustrated in FIG. 33, the acceptance command can be provided as voice command “accept”. Any other voice based command as may be configured can be provided by the user. By way of another example, as illustrated in FIG. 34, the user can provide gesture based command, which by way of example can include “tick-moment”. By way of yet another example, as illustrated in FIG. 35, the user can provide the command via a graphical user interface such as a remote control. By way of example, a “select” key on the remote control can be configured such that upon actuation of the key, the command for “acceptance” can be detected. If the user at the destination device provides the acceptance command, the recommended channel and more particularly, the recommended content can be displayed on the destination device.

The above described method can be adopted in case the user at the recommending device wishes to recommend a stored content which he/she is currently viewing (for example, from a source device). On the other hand, in case the user at the recommending device wishes to recommend a stored content, the user can be provided appropriate interface, an example of which is illustrated in FIG. 36, to select the content. Especially when a stored content is being recommended, the content recommendation message can preferably provide information of the source from where the content can be accessed (or where the content is stored). The information of the source can be any of name of the source device, a unique identification of the source device, manufacturer name of the source device, a nick name of the source, etc.

While specific language has been used to describe the disclosure, any limitations arising on account of the same are not intended. As would be apparent to a person in the art, various working modifications may be made to the method in order to implement the inventive concept as taught herein.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of sending a content recommendation to one or more destination devices for outputting thereupon, the method comprising:
receiving, by a recommending device, a content selection and a selection of one or more destination devices, the content selection pertaining to content available with the recommending device or with a source device connectable to the recommending device; and
sending, based on a status of the selected destination device and information of the content selection, a content recommendation for delivery to the selected destination device.

2. The method as claimed in claim 1, wherein the sending of the content recommendation based on information of the content selection comprises sending at least one of content metadata or preview data corresponding to the content selection.

3. The method as claimed in claim 1, wherein the sending of the content recommendation based on information of the content selection comprises sending a customized text message or a customized multimedia message.

4. The method as claimed in claim 1, wherein the sending of the content recommendation based on information of the content selection comprises sending content metadata or user provided data.

5. The method as claimed in claim 1, wherein the status of the destination device comprises at least one of an “OFF status”, an “ON status” and a “hibernating status”.

6. The method as claimed in claim 1, further comprising:
providing a visual indication of the status of the one or more destination devices.

7. The method as claimed in claim 1, further comprising:
providing a visual indication of the status of the selected destination devices.

8. The method as claimed in claim 1, further comprising:
storing the content recommendation at the recommending device or at an intermediate device in connection with the recommending device, if a status of the selected destination device is an “OFF status”.

9. The method as claimed in claim 1, further comprising:
changing digital right management related information of the content from a first state to a second state, wherein the second state includes a right to view.

10. The method as claimed in claim 1, wherein the recommending device includes a television device.

11. The method as claimed in claim 1, wherein the destination device includes a television device.

12. The method as claimed in claim 1, wherein the receiving of the content selection comprises receiving information of the content, the content being at least one of an ongoing broadcast, a forthcoming broadcast, multimedia content stored within the recommending device, multimedia content available with a source device connectable to the recommending device, webpage content, or a file.

13. The method as claimed in claim 1, wherein the sending of the content recommendation comprises sending at least one of content metadata, broadcast channel metadata, channel information data, preview data corresponding to the content selection, webpage preview data, or file preview data.

14. A recommending device for sending content recommendation to one or more destination devices, the recommending device comprising:
an input unit configured to receive a content selection and a selection of one or more destination devices, the content selection pertaining to content available with the recommending device or with a source device connectable to the recommending device; and
a processing unit coupled with an output unit and configured to send, based on a status of the selected destination device and information of the content selection, a content recommendation for delivery to the selected destination device.

15. A method of sending content from a recommending device to one or more destination devices, the recommending device and the destination device being part of a home network environment, the method comprising:
receiving, by the recommending device, a content selection and a selection of one or more destination devices;
performing, based on at least one predetermined criteria, any one of:
sending information of the content selection for delivery to the selected destination device,
storing information of the content selection for a delayed delivery to the selected destination device,
upgrading information of the content selection at the time of delayed delivery to the selected destination device, or
initiating a recording operation if the content is an ongoing broadcast of “LIVE” nature; and
sending the selected content for delivery to the selected destination device upon receiving an “acceptance” therefrom.

16. A recommending device for sending content to one or more destination devices, the recommending device comprising:
an input unit configured to receive a content selection and a selection of one or more destination devices; and
a processing unit coupled with an output unit and configured to perform, based on at least one predetermined criteria, any one of:
sending information of the content selection for delivery to the selected destination device;
storing information of the content selection for a delayed delivery to the selected destination device;
upgrading information of the content selection at the time of delayed delivery to the selected destination device; or
initiating a recording operation if the content is an ongoing broadcast of “LIVE” nature;
wherein the processor unit is further configured to send the selected content for delivery to the selected destination device upon receiving an “acceptance” therefrom.

17. A method of assisting transmission of content from a recommending device to one or more destination devices, the method comprising:
receiving, by an intermediate device operably connected to the recommending device, information of a destination device and information of content selection; and
identifying a status of the destination device and performing at least one of:
notifying the destination device of the information of content selection, if the destination device is in an ON status; and
storing the information of content selection temporarily if the destination device is in a hibernating status or an OFF status.

18. The method as claimed in claim 17, further comprising:
streaming a content corresponding to the content selection to the at least one destination device if the destination device is in an ON status, based upon at least one predetermined criteria.

19. The method as claimed in claim 18, wherein the at least one pre-determined criteria comprises at least one of:
receiving a content viewing acceptance from the selected destination device; and
availability of the content corresponding to the content selection at the intermediate device.

20. The method as claimed in claim 17, further comprising:
storing content corresponding to the content selection temporarily if the destination device is in a hibernating status, based upon at least one predetermined criteria; and
streaming the content corresponding to the stored information of content selection to the destination device, based upon determining a transition in status of the destination device from a hibernating status to an ON status and receipt of a content viewing acceptance from the selected destination device.

21. The method as claimed in claim 17, further comprising:
upgrading information of the content selection at the time of notifying to the selected destination device.

22. The method as claimed in claim 17, further comprising:
initiating a recording operation.

23. An intermediate device for assisting transmission of content from a recommending device to one or more destination devices, the intermediate device being operably connected to at least one recommending device and at least one destination device, the intermediate device comprising:
a receiving unit configured to receive, from at least one recommending device, information of a destination device, and information of content selection;
a processing unit configured to identify a status of the destination device,
a transmitting unit, being in operational interconnection with the processing unit, configured to notify the destination device of the information of content selection, if the destination device is in an ON status; and
a storage device, being in operational interconnection with the processing unit, configured to store the information of content selection temporarily if the destination device is in a hibernating status or an OFF status.

24. A method of receiving content from a recommending device, the method comprising:
receiving, by a destination device, information of content selection;
presenting, by the destination device, the information of content selection to a user; and
initiating, by the destination device, output of the content corresponding to the information of content selection to the user based on at least one predetermined criteria.

25. The method as claimed in claim 24, wherein the presenting of the information of the content selection comprises transforming the information of the received content selection to a format comprising one or more of an audio format, a text format, a video format and a graphic overlay.

26. The method as claimed in claim 24,
wherein the initiating comprises rendering, by the destination device, an output of the content corresponding to the information of content selection to the user in a selected mode, and
wherein the selected mode comprises one or more of a full screen display, video overlay and a picture-in-picture (PIP) format.

27. The method as claimed in claim 26, wherein the rendering of the output of the content comprises accessing the content selection corresponding to at least one of the stored content or a broadcast content.

28. The method as claimed in claim 27, wherein the stored content is accessed from at least one of the recommending device or an intermediate device.

29. The method as claimed in claim 26, wherein the predetermined condition includes receiving an acceptance from the user for initiating output of the content.

30. A method performed by a destination device for receiving and outputting a content from a recommending device, the device comprising:
a receiving unit configured to receive information of content selection;
a processing unit operatively coupled to an output unit configured to present the information of content selection to a user and prompting the user to provide an acceptance for initiating output of the content; and
an input unit configured to receive an input from the user,
wherein the processing unit and the receiving unit are adapted to receive a content corresponding to the content selection, and
wherein the processing unit and the output unit are adapted to output the content corresponding to the information of content selection to the user.
